(19) United States
(12) Patent Application Publication
(10) Pub. No.: US 2026/0164495 A1
(43) Pub. Date: Jun. 11, 2026

(54) CELL GROUP CONFIGURATION FOR DUAL CONNECTIVITY AND MOBILITY PROCEDURES

(71) Applicant: QUALCOMM Incorporated, San Diego, CA (US)

(72) Inventors: Karthika PALADUGU, Hyderabad (IN); Karl Georg HAMPEL, Jersey City, NJ (US); Naeem AKL, Bridgewater, NJ (US); Gavin Bernard HORN, La Jolla, CA (US); Ozcan OZTURK, San Diego, CA (US); Shankar KRISHNAN, Poway, CA (US)

(21) Appl. No.: 18/974,515

(22) Filed: Dec. 9, 2024

(51) Int. Cl. H04W 76/27; H04W 74/0833; H04W 76/15; H04W 88/06

(52) U.S. Cl. CPC H04W 76/27; H04W 74/0833; H04W 76/15; H04W 88/06

(57) ABSTRACT

Various aspects of the present disclosure generally relate to wireless communication. In some aspects, a user equipment (UE) may establish a first radio resource control (RRC) connection with a network node via a first cell group. The UE may receive signaling indicating a configuration for a second cell group, wherein the configuration comprises an indication of whether the network node supports dual connectivity for the UE via the second cell group, whether the network node supports a mobility procedure for the UE via the second cell group, or both. The UE may establish, with the network node via the second cell group, a second RRC connection for the dual connectivity or for the mobility procedure based at least in part on whether the network node supports the dual connectivity, the mobility procedure, or both via the second cell group. Numerous other aspects are described.

### FIELD OF THE DISCLOSURE

Aspects of the present disclosure generally relate to wireless communication and specifically relate to techniques, apparatuses, and methods associated with cell group configuration for dual connectivity and mobility procedures.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication networks, a network node may configure one or more cell groups to support communications with a user equipment (UE). In some cases, the network node may configure one or two active cell groups to support communications between the UE and the network node. For example, the network node may configure a first active master cell group and a second active secondary cell group to support dual connectivity for the UE. Additionally, the network node may configure one or more deactivated cell groups. For example, the network node may configure one or more deactivated secondary cell groups, one or more candidate secondary cell groups, or one or more candidate cell groups. For each configured cell group, the UE may perform measurement procedures, radio link monitoring, beam failure detection, or active communications based on whether a cell group is configured as an active master cell group, an active secondary cell group, a deactivated secondary cell group, a candidate secondary cell group, or a candidate cell group.

### SUMMARY

Some aspects described herein relate to a method of wireless communication performed by a user equipment (UE). The method may include establishing a first radio resource control (RRC) connection with a network node via a first cell group. The method may include receiving signaling indicating a configuration for a second cell group, wherein the configuration comprises an indication of whether the network node supports dual connectivity for the UE via the second cell group, whether the network node supports a mobility procedure for the UE via the second cell group, or both. The method may include establishing, with the network node via the second cell group, a second RRC connection for the dual connectivity or for the mobility procedure based at least in part on whether the network node supports the dual connectivity, the mobility procedure, or both via the second cell group.

Some aspects described herein relate to a method of wireless communication performed by a network node. The method may include establish a first RRC connection with a UE via a first cell group. The method may include transmitting signaling indicating a configuration for a second cell group, wherein the configuration comprises an indication of whether the network node supports dual connectivity for the UE via the second cell group, whether the network node supports a mobility procedure for the UE via the second cell group, or both. The method may include establishing, with the UE via the second cell group, a second RRC connection for the dual connectivity or for the mobility procedure based at least in part on whether the network node supports the dual connectivity, the mobility procedure, or both via the second cell group.

Some aspects described herein relate to an apparatus for wireless communication at a UE. The apparatus may include one or more memories and one or more processors coupled to the one or more memories. The one or more processors may be configured to establish a first RRC connection with a network node via a first cell group. The one or more processors may be configured to receive signaling indicating a configuration for a second cell group, wherein the configuration comprises an indication of whether the network node supports dual connectivity for the UE via the second cell group, whether the network node supports a mobility procedure for the UE via the second cell group, or both. The one or more processors may be configured to establish, with the network node via the second cell group, a second RRC connection for the dual connectivity or for the mobility procedure based at least in part on whether the network node supports the dual connectivity, the mobility procedure, or both via the second cell group.

Some aspects described herein relate to an apparatus for wireless communication at a network node. The apparatus may include one or more memories and one or more processors coupled to the one or more memories. The one or more processors may be configured to establish a first RRC connection with a UE via a first cell group. The one or more processors may be configured to transmit signaling indicating a configuration for a second cell group, wherein the configuration comprises an indication of whether the network node supports dual connectivity for the UE via the second cell group, whether the network node supports a mobility procedure for the UE via the second cell group, or both. The one or more processors may be configured to establish, with the UE via the second cell group, a second RRC connection for the dual connectivity or for the mobility procedure based at least in part on whether the network node supports the dual connectivity, the mobility procedure, or both via the second cell group.

Some aspects described herein relate to a non-transitory computer-readable medium that stores a set of instructions for wireless communication by a UE. The set of instructions, when executed by one or more processors of the UE, may cause the UE to establish a first RRC connection with a network node via a first cell group. The set of instructions, when executed by one or more processors of the UE, may cause the UE to receive signaling indicating a configuration for a second cell group, wherein the configuration comprises an indication of whether the network node supports dual connectivity for the UE via the second cell group, whether the network node supports a mobility procedure for the UE via the second cell group, or both. The set of instructions, when executed by one or more processors of the UE, may cause the UE to establish, with the network node via the second cell group, a second RRC connection for the dual connectivity or for the mobility procedure based at least in part on whether the network node supports the dual connectivity, the mobility procedure, or both via the second cell group.

Some aspects described herein relate to a non-transitory computer-readable medium that stores a set of instructions for wireless communication by a network node. The set of instructions, when executed by one or more processors of the network node, may cause the network node to establish a first RRC connection with a UE via a first cell group. The set of instructions, when executed by one or more processors of the network node, may cause the network node to transmit signaling indicating a configuration for a second cell group, wherein the configuration comprises an indication of whether the network node supports dual connectivity for the UE via the second cell group, whether the network node supports a mobility procedure for the UE via the second cell group, or both. The set of instructions, when executed by one or more processors of the network node, may cause the network node to establish, with the UE via the second cell group, a second RRC connection for the dual connectivity or for the mobility procedure based at least in part on whether the network node supports the dual connectivity, the mobility procedure, or both via the second cell group.

Some aspects described herein relate to an apparatus for wireless communication. The apparatus may include means for establishing a first RRC connection with a network node via a first cell group. The apparatus may include means for receiving signaling indicating a configuration for a second cell group, wherein the configuration comprises an indication of whether the network node supports dual connectivity for the UE via the second cell group, whether the network node supports a mobility procedure for the UE via the second cell group, or both. The apparatus may include means for establishing, with the network node via the second cell group, a second RRC connection for the dual connectivity or for the mobility procedure based at least in part on whether the network node supports the dual connectivity, the mobility procedure, or both via the second cell group.

Some aspects described herein relate to an apparatus for wireless communication. The apparatus may include means for establishing a first RRC connection with a UE via a first cell group. The apparatus may include means for transmitting signaling indicating a configuration for a second cell group, wherein the configuration comprises an indication of whether the network node supports dual connectivity for the UE via the second cell group, whether the network node supports a mobility procedure for the UE via the second cell group, or both. The apparatus may include means for establishing, with the UE via the second cell group, a second RRC connection for the dual connectivity or for the mobility procedure based at least in part on whether the network node supports the dual connectivity, the mobility procedure, or both via the second cell group.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example wireless communication network illustrating a user equipment (UE) that is communicating using dual connectivity, in accordance with the present disclosure.

FIGS. 4-9 are diagrams illustrating examples associated with cell group configuration for dual connectivity and mobility procedures, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a network node may configure one or more cell groups to support communications with a user equipment (UE). For example, the network node may configure one or more active cell groups to support communications between the UE and the network node. In some cases, the active cell group may correspond to an active master cell group or an active secondary cell group. That is, the network node may configure a first active master cell group and a second active secondary cell group to support dual connectivity for the UE. Additionally, the network node may configure one or more deactivated cell groups. For example, the network node may configure one or more deactivated secondary cell groups (e.g., for dual connectivity), one or more candidate secondary cell groups (e.g., for a conditional handover procedure), or one or more candidate cell groups (e.g., for lower layer triggered mobility procedures). For each configured cell group, the UE may perform measurement procedures, radio link monitoring, beam failure detection, or active communications based on whether a cell group is configured as an active master cell group, an active secondary cell group, a deactivated secondary cell group, a candidate secondary cell group, or a secondary cell group.

In some other wireless communication networks, a UE may be capable of communicating with a network node via multiple cell groups without one of the cell groups being configured as a master cell group and another one of the cell groups being configured as a secondary cell group. For example, the UE may be capable of communicating with a network node that includes a central unit (CU) via two cell groups: a first cell group that is associated with a first distributed unit (DU) and a second cell group that is associated with a second DU. In some cases, both the first and second DUs may be associated with (e.g., controlled by) the single network node including the CU (e.g., an anchor CU). Accordingly, the CU may coordinate communications between the first and second DUs (e.g., rather than one of the DUs being associated with a master cell group that coordinates communications for the master cell group and the secondary cell group).

When the UE is capable of communicating with the CU via multiple cell groups without a master cell group and one or more secondary cell groups, the network node may configure cell groups as either active cell groups or candidate cell groups. As part of configuring the cell groups, the network node may additionally indicate whether the network node supports the UE performing dual connectivity with a cell group, the UE performing a mobility procedure with the cell group, or both. That is, the network node may configure one or more cell groups for which the network node supports dual connectivity but does not support mobility procedures. Additionally, the network node may configure one or more cell groups for which the network node supports mobility procedures but does not support dual connectivity. Further, the network node may configure one or more cell groups for which the network node supports both dual connectivity and mobility procedures. Accordingly, for each cell group configuration, the network node may indicate whether the cell group is configured as an active cell group or a candidate cell group, and whether the network node is configuring the cell group to support dual connectivity, mobility procedures, or both.

Particular aspects of the subject matter described in this disclosure can be implemented to realize one or more of the following potential advantages. In some examples, the described techniques can be used to simplify a configuration of cell groups. That is, by reducing a quantity of cell group configuration types (e.g., from active master cell groups, active secondary cell groups, deactivated secondary cell groups, candidate secondary cell groups, and candidate cell groups to active cell groups and deactivated cell groups), a complexity of the signaling associated with configuring cell groups may be decreased, thus improving a latency associated with configuring one or more cell groups. Additionally, reducing the quantity of cell group configuration types may further improve a flexibility of cell group configurations. That is, the network node may configure a single cell group that is capable of supporting more functionality, which may further improve communication efficiency.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

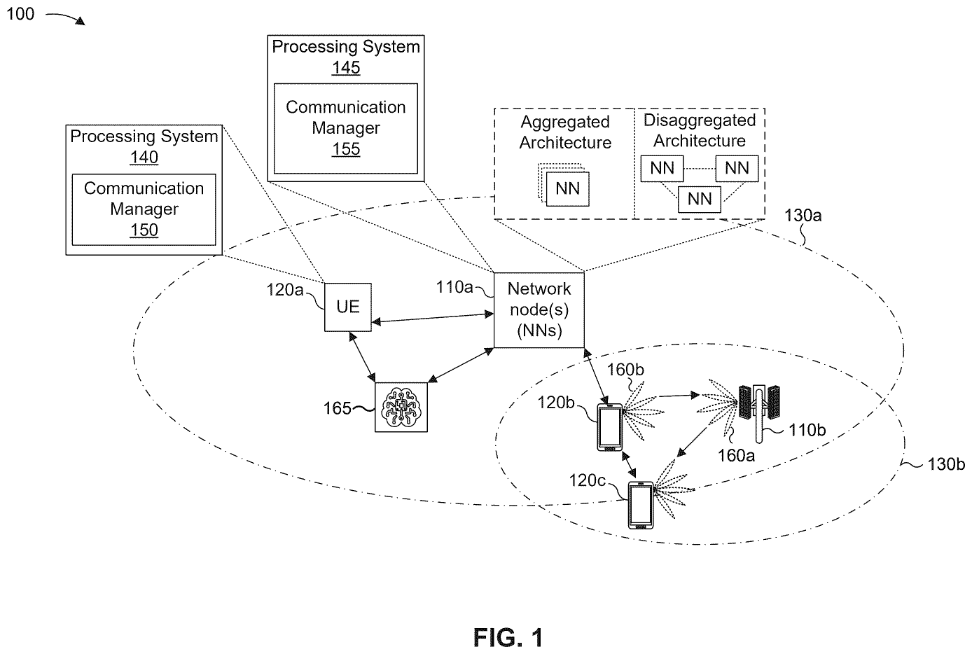

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

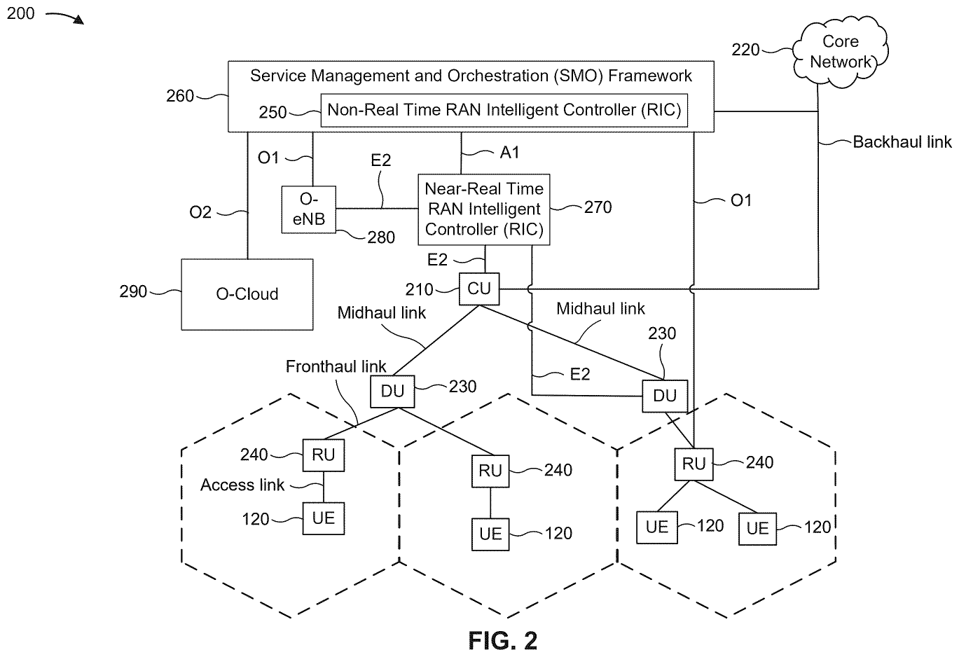

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may establish a first RRC connection with a network node via a first cell group; receive signaling indicating a configuration for a second cell group, wherein the configuration comprises an indication of whether the network node supports dual connectivity for the UE via the second cell group, whether the network node supports a mobility procedure for the UE via the second cell group, or both; and establish, with the network node via the second cell group, a second RRC connection for the dual connectivity or for the mobility procedure based at least in part on whether the network node supports the dual connectivity, the mobility procedure, or both via the second cell group. Additionally, or alternatively, the communication manager 150 may perform one or more other operations described herein.

In some aspects, the network node 110 may include a communication manager 155. As described in more detail elsewhere herein, the communication manager 155 may establish a first RRC connection with a UE via a first cell group; transmit signaling indicating a configuration for a second cell group, wherein the configuration comprises an indication of whether the network node supports dual connectivity for the UE via the second cell group, whether the network node supports a mobility procedure for the UE via the second cell group, or both; and establish, with the UE via the second cell group, a second RRC connection for the dual connectivity or for the mobility procedure based at least in part on whether the network node supports the dual connectivity, the mobility procedure, or both via the second cell group. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

In some examples, the disaggregated network node architecture 200 may be associated with a 5G core network. For example, the DUs 230 and the CUs 210 may be associated with a 5G core network. In such examples, the CUS 210 and DUs 230 may be associated with a functional split. That is, the CUS 210 may perform UE-related tasks such as radio bearer management and UE mobility. The CUs 210 may interface to the UE 120 via RRC connections and may interface to the DUs 230 via an F1 interface (e.g., an F1-C interface). Further, the CUs 210 may interface with other CUs 210 via an Xn interface. Additionally, in 5G core networks, the DUs 230 may manage radio resources of the cells (e.g., the cell groups 305). Further, the DUs 230 may exchange signaling with the UE 120 via MAC-CEs or PHY-layer signaling. In some examples of 5G networks, each CU 210 may be capable of interfacing with multiple DUs 230, but each DU 230 may only interface with a single CU 210. Accordingly, coordinating between DUs 230 that are associated with different CUs 210 may be complex, as the different CUs 210 may in turn coordinate bearer management across both DUs 230.

As a result of this complexity, 5G core networks may rely on master nodes and secondary nodes to support dual connectivity. The dual connectivity may correspond to an Evolved Universal Mobile Telecommunications System Terrestrial Radio Access (E-UTRA)-NR dual connectivity (ENDC) mode. In the ENDC mode, a UE 120 communicates using an LTE RAT on a master cell group, and the UE 120 communicates using an NR RAT on a secondary cell group. Additionally, the dual connectivity may correspond to an NR-E-UTRA dual connectivity (NEDC) mode (e.g., where the master cell group is associated with an NR RAT and the secondary cell group is associated with an LTE RAT), an NR dual connectivity (NRDC) mode (e.g., where the master cell group is associated with an NR RAT and the secondary cell group is also associated with the NR RAT), or another dual connectivity mode (e.g., where the master cell group is associated with a first RAT and the secondary cell group is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

In some cases, the UE 120 may support two concurrent RRC connections (e.g., one via the master node and one via the secondary node) that are associated with separate security associations. When the wireless communication network includes master nodes and secondary nodes, if the UE 120 moves, a change of the master node may be coordinated separately from a change of the secondary node, which may result in increased signaling overhead (e.g., as compared to a change of the master node and secondary node that are coordinated together). Additionally, the procedures associated with different types of mobility procedures (e.g., a dual active protocol stack (DAPS) handover, a conditional handover, a lower layer triggered mobility procedure, a RACH-less handover) may be associated with different configurations and coordination, which may further increase signaling overhead and increase complexity.

In some cases of the disaggregated network node architecture 200, network nodes (such as DUs 230, CUs 210, or some other network node 110 associated with the core network 220) may configure various types of cell groups. For example, a network node may configure a master cell group, a deactivated secondary cell group, a candidate secondary cell group, a candidate cell group, and/or an activated secondary cell group. For each configured cell group, a UE 120 may perform measurement procedures, radio link monitoring, beam failure detection, or active communications based on a type of the configured cell group. An example of the various configurations for different types of cell groups is illustrated below in Table 1.

TABLE 1
Cell Group Type Configurations

| | | Deactivated | Candidate | |
|---|---|---|---|---|
| | Master Cell | Secondary | Secondary | Candidate |
| Procedure | Group | Cell Group | Cell Groups | Cell Group |
| Active Uplink | Yes | No | No | No |
| and/or | | | | |
| Downlink | | | | |
| Transmissions | | | | |
| L3 | Yes | Yes | Yes | Yes |
| Measurements | | | | |
| and/or | | | | |
| Reporting | | | | |
| L1 | Yes | No | No | Yes |
| Measurements | | | | |
| and/or | | | | |
| Reporting | | | | |
| Radio Link | Yes | Yes or No | No | No |
| Monitoring | | (Configurable) | | |
| Beam Failure | Yes | Yes or No | No | No |
| Detection | | (Configurable) | | |

In the example illustrated by Table 1, a UE 120 may be configured to perform a lower layer triggered mobility procedure using the master cell group. Here, the UE 120 may be configured to perform, using the master cell group, uplink and/or downlink transmissions (e.g., by PDCCH, PDSCH, PUCCH, PUSCH), layer 3 (L3) measurements and reporting (e.g., cell measurements and reporting, beam measurements and reporting), L1 measurements and reporting, radio link monitoring, and beam failure detection. In another example illustrated by Table 1, a UE 120 may be configured with a deactivated secondary cell group for 5G NR-DC. Here, the UE 120 may not be configured to perform, via the deactivated secondary cell group, active uplink and/or downlink transmissions or L1 measurements and reporting, and the UE 120 may be configured to perform, via the deactivated secondary cell group, L3 measurements and reporting. Further, the UE 120 may optionally be configured to perform, via the deactivated secondary cell group, radio link monitoring or beam failure detection.

In another example illustrated by Table 1, a UE 120 may be configured with a candidate secondary cell group for a 5G NR-DC conditional change. Here, the UE 120 may not be configured to perform, via the candidate secondary cell group, active uplink and/or downlink transmissions, L1 measurements and reporting, radio link monitoring, or beam failure detection, and the UE 120 may be configured to perform, via the candidate secondary cell group, L3 measurements and reporting. In another example illustrated by Table 1, a UE 120 may be configured with a candidate cell group for a lower layer triggered mobility procedure. Here, the UE 120 may not be configured to perform, via the candidate cell group, active uplink and/or downlink transmissions, radio link monitoring, or beam failure detection, and the UE 120 may be configured to perform, via the candidate secondary cell group, L3 measurements and reporting and L1 measurements and reporting.

In some other examples of the disaggregated network node architecture 200, a UE 120 may be configured with one or more active cell groups and one or more candidate cell groups (e.g., and may not be configured with any other type of cell group). Here, a functionality of deactivated secondary cell groups and candidate cell groups may be provided by the candidate cell groups. In particular, the candidate cell groups may be configured to enable the UE 120 to perform L1 measurements and reporting (e.g., for a mobility procedure, such as a DU controlled mobility procedure) via the candidate cell groups. Additionally, the candidate cell groups may be configured to enable the UE 120 to perform radio link monitoring and/or beam failure detection using the candidate cell groups. In some cases, a network node may configure radio link monitoring and beam failure detection on candidate cell groups based on a power saving parameter associated with the UE 120.

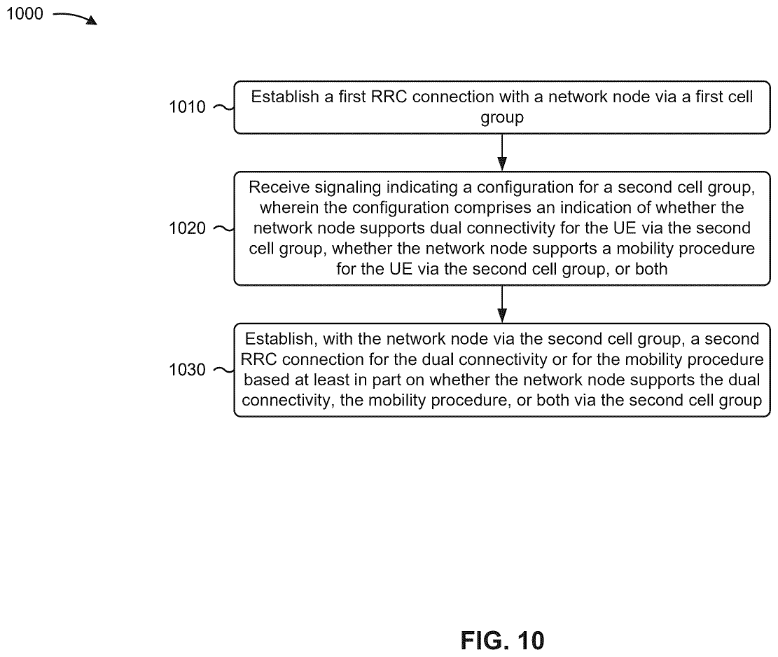

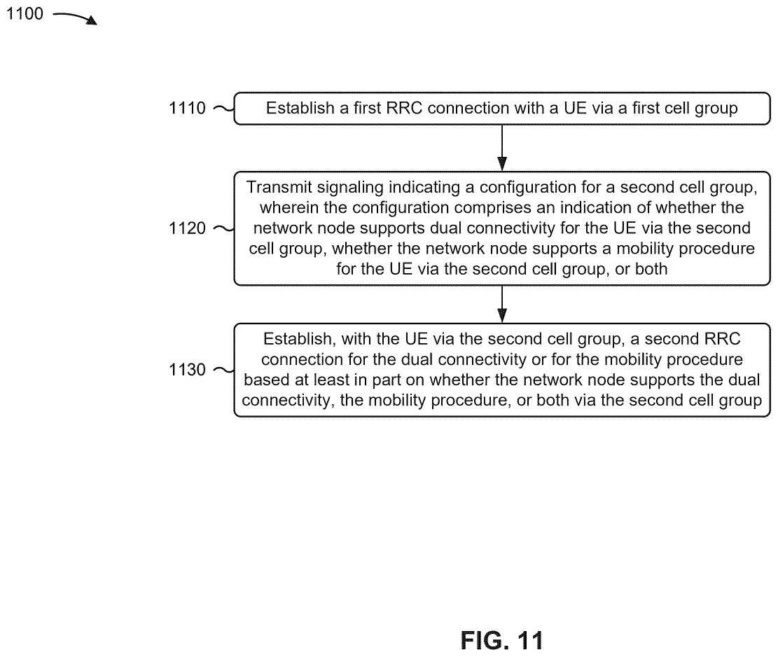

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with cell group configuration for dual connectivity and mobility procedures, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

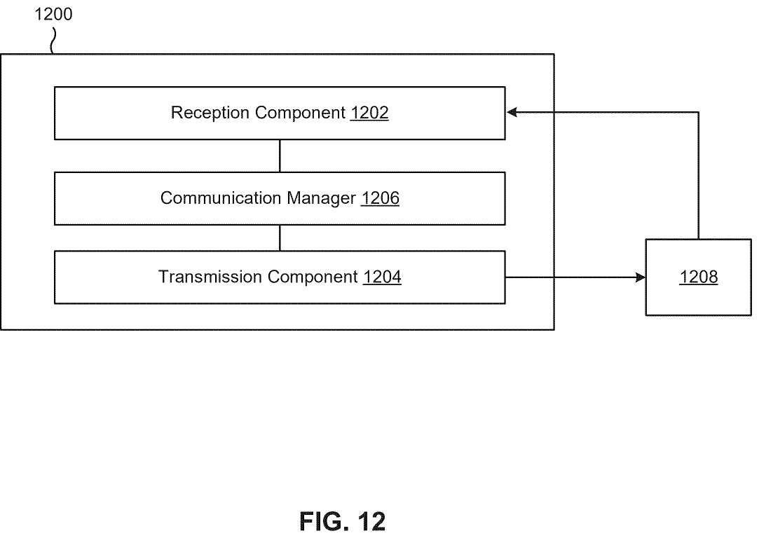

In some aspects, the UE 120 includes means for establishing a first RRC connection with a network node via a first cell group; means for receiving signaling indicating a configuration for a second cell group, wherein the configuration comprises an indication of whether the network node supports dual connectivity for the UE 120 via the second cell group, whether the network node supports a mobility procedure for the UE 120 via the second cell group, or both; and/or means for establishing, with the network node via the second cell group, a second RRC connection for the dual connectivity or for the mobility procedure based at least in part on whether the network node supports the dual connectivity, the mobility procedure, or both via the second cell group. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

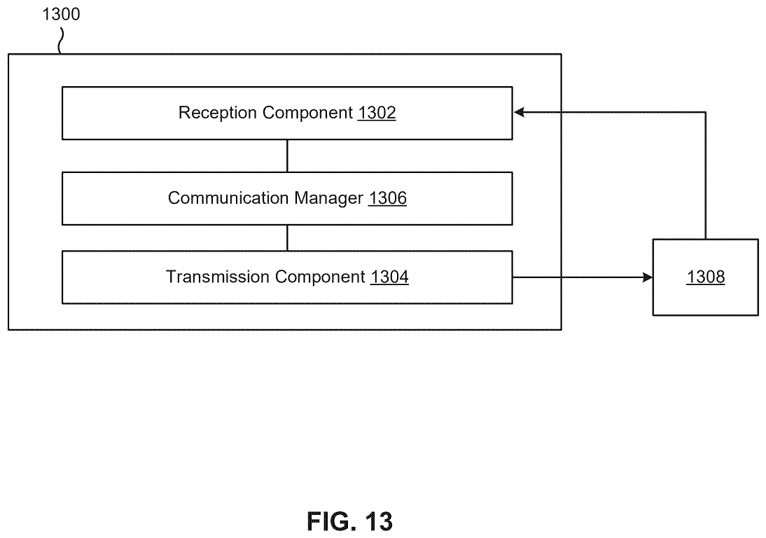

In some aspects, the network node 110 includes means for establish a first RRC connection with a UE 120 via a first cell group; means for transmitting signaling indicating a configuration for a second cell group, wherein the configuration comprises an indication of whether the network node supports dual connectivity for the UE 120 via the second cell group, whether the network node supports a mobility procedure for the UE via the second cell group, or both; and/or means for establishing, with the UE 120 via the second cell group, a second RRC connection for the dual connectivity or for the mobility procedure based at least in part on whether the network node supports the dual connectivity, the mobility procedure, or both via the second cell group. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

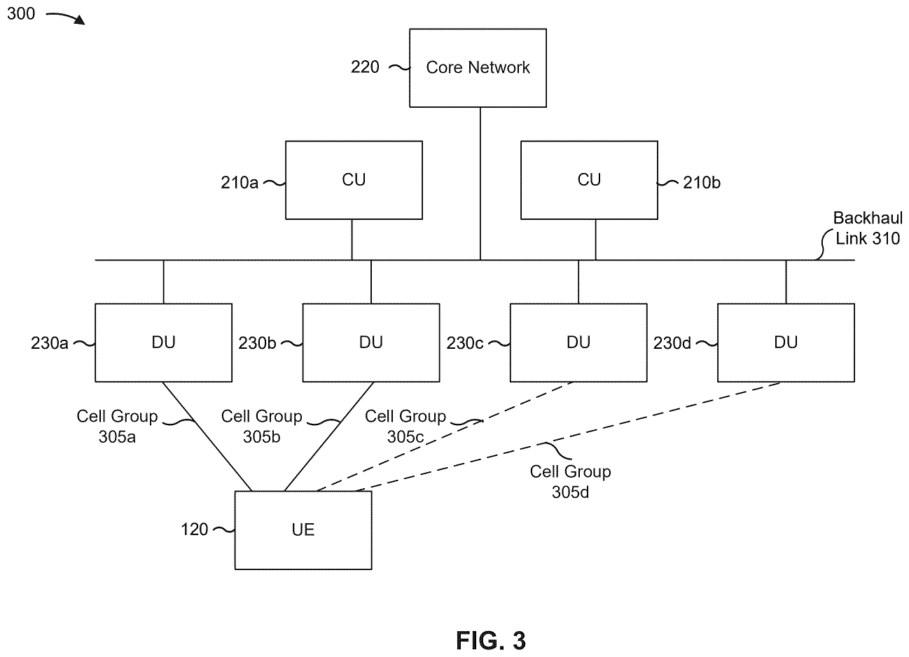

FIG. 3 is a diagram illustrating an example wireless communication network 300 illustrating a UE 120 that is communicating using dual connectivity, in accordance with the present disclosure. FIG. 3 illustrates the UE 120 communicating via a first cell group 305a associated with a first DU 230a and a second cell group 305b associated with a second DU 230b. The wireless communication network 300 may additionally include a third DU 230c associated with a third cell group 305c, a fourth DU 230d associated with a fourth cell group 305d, a first CU 210a, a second CU 210b, and a core network 220. In the example wireless communication network 300, the core network 220 may correspond to a 6G core network.

In the example communication network 300, the UE 120 may be controlled by a single CU 210 while being connected to one or more DUs 230. For example, the UE 120 may be controlled by the CU 210a while being connected to the DU 230a and the DU 230b. In some cases, the multiple connections between the UE 120 and the single CU 210a (e.g., via the DU 230a and the DU 230b) may not include a master or secondary connection. Instead, the single CU 210a may control and coordinate the multiple connections (e.g., via the backhaul link 310). In some cases, the backhaul link 310 may correspond to a point to point interface or an API. As a result, the UE 120 may maintain a single security association for the multiple connections (e.g., as opposed to separate security associations for each connection). Additionally, multiple CUs 210 may not coordinate the multiple connections for the UE 120. Further, a single RRC state at the UE 120 and the CU 210a may be associated with the multiple connections. In some cases, the single CU 210a controlling the UE 120 may prevent a requirement for inter-CU 210 data forwarding.

Because the connections between the UE 120 and the CU 210a do not include a master cell group and a secondary cell group, a complexity of mobility procedures and dual connectivity may be decreased (e.g., as compared to connections that do include master cell groups and secondary cell groups). For example, the UE 120 may perform similar procedures to add, change, or release either cell group 305a or cell group 305b. That is, the UE 120 may not need to perform separate procedures for a master cell group and a secondary cell group. Further, the UE 120 may perform a same process if either cell group 305a or cell group 305b fails (e.g., a single failure) as opposed to separate procedures based on whether a master cell group or a secondary cell group fails. Further, while the example wireless communication network 300 illustrates the UE 120 being connected to two DUs 230 via two cell groups 305, the UE 120 may be connected to more DUs 230 (e.g., three DUs 230 via three cell groups 305, four DUs 230 via four cell groups 305) or fewer DUs 230 (e.g., one DU 230 via one cell group 305).

A network node (e.g., such as the CU 210a via the DU 230a or the DU 230b) may configure the UE 120 with one or more cell groups 305 (e.g., a cell group set). In some cases, the UE 120, in a connected mode, may support more than one type of cell group in the cell group set of that UE 120. The configured cell groups 305 may correspond to an active cell group or a candidate cell group. In the example wireless communication network 300, the network node (e.g., the CU 210a) may configure the cell group set for the UE 120 to include the cell group 305a, the cell group 305b, the cell group 305c, and the cell group 305d. Additionally, the network node may configure the cell group 305a and the cell group 305b as active cell groups for the UE 120 and may configure the cell group 305c and the cell group 305d as candidate cell groups for the UE 120.

An active cell group 305 (e.g., the cell group 305a and the cell group 305b) may be a cell group via which the UE 120 is connected to the core network 220 and is configured with signal radio bearer and data radio bearer resources. A UE 120 may support normal radio resource management, radio link monitoring, and communication (e.g., transmission or reception) procedures via an active cell group 305. A candidate cell group 305 (e.g., the cell group 305c and the cell group 305d) may be a cell group that is prepared (e.g., via the network node) for different functions such as dual connectivity or mobility procedures, and is kept in a deactivated state with no radio resources until an activation of the candidate cell group 305. A UE 120 may support limited radio resource management, radio link monitoring, or beam failure detection procedures for candidate cell groups 305 (e.g., based on a power saving metric associated with the UE 120, in accordance with a configuration for the candidate cell group 305). In some cases, the network node may configure the UE 120 to perform L3 and L1 measurements and reporting for both active cell groups 305 and candidate cell groups 305.

The example shown in FIG. 3 illustrates the UE 120 communicating with a network node (e.g., the CU 210a) via a dual connectivity connection. In particular, the UE 120 may have established a first RRC connection with the network node via a first cell group 305a and established a second RRC connection with the network node via a second cell group 305b. The UE 120 may communicate via the first and second cell groups 305 using one or more radio bearers (e.g., data radio bearers and/or signaling radio bearers). For example, the UE 120 may transmit or receive data via the first cell group 305a and the second cell group 305b using one or more data radio bearers. Similarly, the UE 120 may transmit or receive control information (e.g., RRC information and/or measurement reports) using one or more signaling radio bearers. In some aspects, a radio bearer may be dedicated to a specific cell group (e.g., a radio bearer may be dedicated to the first cell group 305a or the second cell group 305b). In some aspects, a radio bearer may be a split radio bearer. A split radio bearer may be split in the uplink and/or in the downlink. For example, a data radio bearer may be split on the downlink (e.g., the UE 120 may receive downlink information for the first cell group 305a or the second cell group 305b via the data radio bearer) but not on the uplink (e.g., the uplink may be non-split with a primary path to the first cell group 305a or the second cell group 305b, such that the UE 120 transmits in the uplink only on the primary path). In some aspects, a data radio bearer may be split on the uplink with a primary path to the first cell group 305a or the second cell group 305b. A data radio bearer that is split in the uplink may transmit data using the primary path until a size of an uplink transmit buffer satisfies an uplink data split threshold. If the uplink transmit buffer satisfies the uplink data split threshold, the UE 120 may transmit data to the first cell group 305a or the second cell group 305b using the data radio bearer.

The wireless communication network 300 may support mobility between active cell groups 305 and candidate cell groups 305. For example, if the UE 120 moves, the CU 210a may activate the candidate cell groups 305c and 305d and deactivate the cell groups 305a and 305b. In some cases, the CU 210a may perform setup and release procedures with the DUs 230 to support the mobility of the UE 120 (e.g., without a master node or secondary node change or a master node handover).

As indicated above, FIG. 3 is provided as an example. Other examples may differ from what is described with respect to FIG. 3.

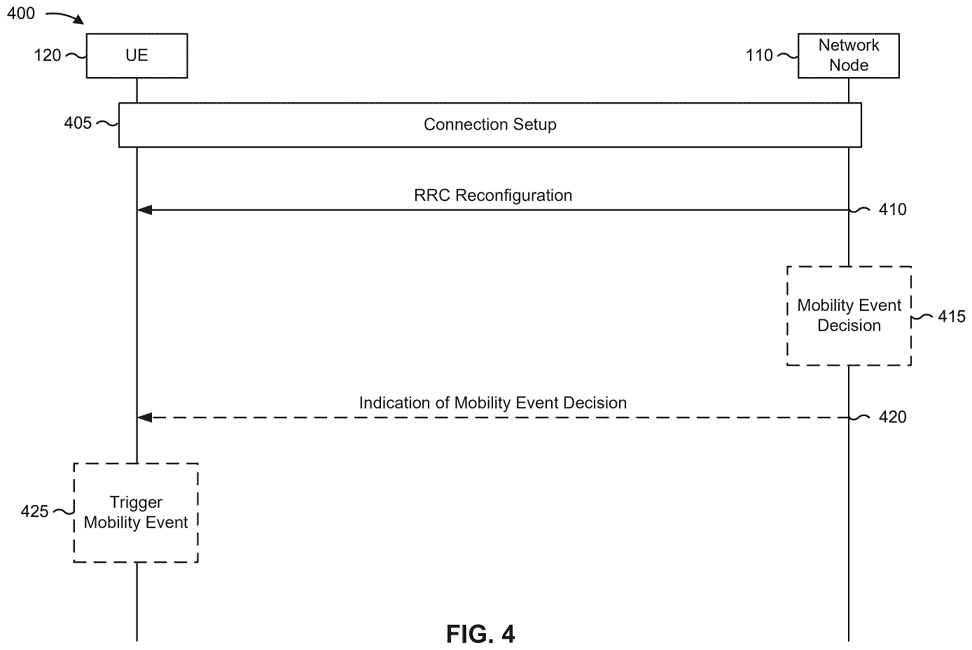

FIG. 4 is a diagram illustrating an example 400 associated with cell group configuration for dual connectivity and mobility procedures, in accordance with the present disclosure. As shown in FIG. 4, a network node 110 and a UE 120 may communicate with one another. The example 400 illustrates one or more operations performed by the network node 110 and the UE 120 to configure cell groups for dual connectivity or mobility procedures. In some cases, the network node 110 may include a DU and/or a CU.

At 405, the UE 120 and the network node 110 may perform a connection setup procedure. In some cases, the connection setup procedure may include the UE 120 transmitting, to the network node 110, an RRC connection request message and the network node 110 transmitting, to the UE 120 based on the RRC connection request message, an RRC connection setup message. Based on performing the connection setup procedure, the UE 120 may establish a first RRC connection with the network node 110 via a first active cell group. In some cases, the network node 110 may include a central unit. Here, the network node 110 may configure the UE 120 to establish the first RRC connection with the network node 110 via a second (e.g., not illustrated) network node that includes a distributed unit. Based on performing the connection setup procedure with the network node at 405, the UE 120 may have a first RRC connection via a first active cell group with the network node. Accordingly, the UE 120 may be in a connected mode based on performing the connection setup procedure.

At 410, the network node 110 may transmit, and the UE 120 may receive, an RRC reconfiguration message. The RRC reconfiguration message may configure a candidate cell group for the UE 120. That is, the RRC reconfiguration message may configure a candidate cell group, in a set of cell groups for the UE 120. The RRC reconfiguration message may include an indication of a candidate cell group and a configuration for the candidate cell group. The configuration for the candidate cell group may include a candidate cell group suitability indication that indicates whether the network node 110 supports dual connectivity for the UE 120 via the candidate cell group, whether the network node 110 supports a mobility procedure for the UE 120 via the candidate cell group, or whether the network node 110 supports dual connectivity and a mobility procedure for the UE 120 via the candidate cell group. Accordingly, the RRC reconfiguration message may configure a candidate cell group for the UE 120 and may indicate whether the candidate cell group is suitable for (e.g., via a cell group suitability indication within the RRC reconfiguration message) dual connectivity and not a mobility procedure, a mobility procedure and not dual connectivity, or both dual connectivity and a mobility procedure.

If the network node 110 indicates that the candidate cell group is suitable for a dual connectivity of the UE 120, the network node 110 may optionally configure the candidate cell group for a UE-triggered dual connectivity establishment. Here, the network node 110 may additionally indicate, via the RRC reconfiguration message, one or more conditions associated with the UE 120 establishing a dual connectivity connection with the network node 110 via the candidate cell group (e.g., one or more triggers for the UE to activate dual connectivity with the network node 110 via the candidate cell group).

If the network node 110 indicates that the candidate cell group is suitable for a mobility procedure for the UE 120, the RRC reconfiguration message may optionally indicate a type of mobility procedure for which the candidate cell group is suitable. For example, the network node 110 may configure the candidate cell group to support a normal handover for the UE 120, a conditional handover for the UE 120, a lower layer triggered mobility switch for the UE 120 (e.g., a distributed unit controlled switch of the active cell group(s) for the UE 120), a handover procedure without a random access procedure, or a make-before-break handover (e.g., a DAPS handover). If the network node 110 indicates that the candidate cell group is suitable for a conditional handover via the RRC reconfiguration message, the RRC reconfiguration message may additionally include an indication of one or more conditions associated with the UE 120 performing the conditional handover (e.g., one or more triggers for the UE 120 to perform the conditional handover from the first active cell group to the candidate cell group).

At 415 and 420, the network node 110 may optionally trigger the UE 120 to activate a candidate cell group for either a mobility procedure or to activate dual connectivity. That is, the network node 110 may perform the operations illustrated and described with reference to 415 and 420 if the activation of the candidate cell group is in response to a DU or CU triggered event.

At 415, the network node 110 may make a mobility event decision. In particular, the network node 110 may determine for the UE 120 to perform a mobility procedure or to activate dual connectivity. The network node 110 may make the mobility event decision based on one or more capabilities of the UE 120, one or more measurements (e.g., L1 measurements performed by the UE 120, L3 measurements performed by the UE 120, one or measurements performed by the network node 110), a service requirement associated with communications between the UE 120 and the network node 110, or an external trigger.

At 420, the network node 110 may optionally transmit, and the UE 120 may receive, an indication of the mobility event decision. For example, the network node 110 may transmit an indication for the UE 120 to activate dual connectivity using the candidate cell group or for the UE 120 to perform a mobility procedure from the first active cell group to the candidate cell group. The network node 110 may transmit the indication of the mobility event decision via an RRC reconfiguration message (e.g., for activating dual connectivity, for a make-before-break handover), or via an L2 command (e.g., for a lower-layer triggered mobility procedure, for activating dual connectivity, for a make-before-break handover) such as a MAC-CE or via an L1 command. In some cases, the UE 120 may activate the candidate cell group for either dual connectivity or a mobility procedure in accordance with the mobility event decision and/or the cell group suitability indication associated with the candidate cell group.

At 425, the UE 120 may optionally trigger a mobility event. That is, the UE 120 may perform the operations illustrated and described with reference to 425 if the UE triggers a dual connectivity activation or a mobility procedure (e.g., based on determining that a condition associated with the mobility event is satisfied). For example, the UE 120 may activate a cell group for dual connectivity based on determining that a condition associated with the cell group (e.g., as indicated by the configuration of that cell group) for dual connectivity is satisfied. Additionally, the UE 120 may activate a cell group for a mobility procedure (e.g., as part of a conditional handover) based on determining that a condition associated with the cell group for the mobility procedure is satisfied. In some cases, at 425 the UE 120 may determine to perform a conditional handover to the candidate cell group if one or more of the conditions associated with the conditional handover are satisfied. In another case, the UE 120 may determine to activate dual connectivity via the candidate cell group if one or more of the conditions associated with the dual connectivity are satisfied. In another example, the UE 120 may perform a handover procedure without a random access procedure if such a mobility procedure is applicable to the mobility event (e.g., as triggered by the UE 120 at 425).

As indicated above, FIG. 4 is provided as an example. Other examples may differ from what is described with respect to FIG. 4.

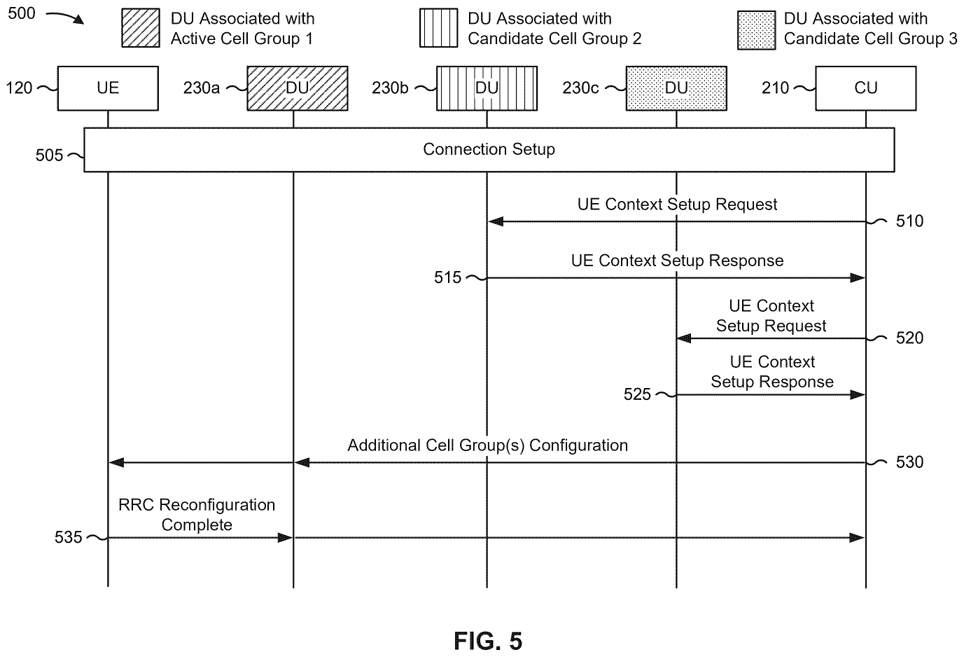

FIG. 5 is a diagram illustrating an example 500 associated with cell group configuration for dual connectivity and mobility procedures, in accordance with the present disclosure. In some cases, a UE 120 that performs the one or more operations illustrated with respect to the example 400 of FIG. 4 may additionally perform the one or more operations illustrated with respect to the example 500 of FIG. 5. In particular, the example 500 illustrates one or more operations associated with the configuration of the one or more cell groups for dual connectivity or mobility procedures.

As shown in FIG. 5, a UE 120, a DU 230a, a DU 230b, a DU 230c, and a CU 210 may communicate with one another. In some cases, a first network node 110 may include the DU 230a, a second network node 110 may include the DU 230b, a third network node may include the DU 230c, and a fourth network node 110 may include the CU 210. Additionally, or alternatively, a single network node 110 may include more than one of the DUs 230 and/or the CU 210. In the example 500, the DU 230a may support a first cell group (e.g., the cell group 1), the DU 230b may support a second cell group (e.g., the cell group 2), and the DU 230c may support a third cell group (e.g., the cell group 3).

At 505, the CU 210 may perform a connection setup procedure with the UE 120. In the example 500, the CU 210 may perform the connection setup procedure with the UE 120 via the DU 230a to establish an RRC connection with the UE 120 via the first cell group. The connection setup procedure may include the UE 120 transmitting, to the CU 210 via the DU 230a, an RRC connection request message, and the CU 210 transmitting, to the UE 120 via the DU 230a and based on the RRC connection request message, an RRC connection setup message. Based on performing the connection setup procedure, the UE 120 may have a first RRC connection via the active cell group 1 (e.g., that is associated with the DU 230a) with the CU 210.

After performing the connection setup procedure with the UE 120 (e.g., after the UE 120 is in a connected mode), the CU 210 may set up additional UE contexts for the candidate DUs 230 (e.g., the DU 230b and the DU 230c) to configure additional candidate cell group resources for the UE 120. During the UE context setup procedure, the CU 210 may indicate, to the associated DU 230, whether the cell group associated with the associated DU 230 is to be activated, whether the cell group is configured for dual connectivity activation, a mobility procedure, or both (e.g., via a cell group suitability indication), and a configuration of the cell group to support dual connectivity activation and/or a configuration of the cell group to support mobility procedures.

At 510 and 515, the CU may perform a UE context setup procedure with the DU 230b. In particular, at 510 the CU 210 may transmit, and the DU 230b may receive, a UE context setup request message. The CU 210 may transmit the UE context setup request message over a point to point interface or via an API over a Service Based Interface (SBI). The UE context setup request message may indicate one or more bearers (e.g., one or more data radio bearers, one or more signaling radio bearers) associated with the second cell group for the DU 230b to establish with the UE 120 for that context. In some cases, the one or more bearers may be associated with one or more layers of a protocol stack of the UE 120.

The UE context setup request message may additionally include an indication of the second cell group for the DU 230b to support for communications between the UE 120 and the CU 210, an indication of whether the second cell group is active or deactivated (e.g., whether the cell group is an active cell group or a candidate cell group within the set of cell groups configured for the UE 120), and a cell group suitability indication associated with the second cell group. In the example 500, the UE context setup request message may indicate that the second cell group is a candidate cell group (e.g., is deactivated). The cell group suitability indication within the UE context setup request message may indicate whether the CU 210 supports dual connectivity for the UE 120 via the second cell group (e.g., and not mobility procedures), whether the CU 210 supports mobility procedures for the UE 120 via the second cell group (e.g., and not dual connectivity), or whether the CU 210 supports both dual connectivity and mobility procedures for the UE 120 via the second cell group.

At 515, the DU 230b may transmit, and the CU 210 may receive, a UE context setup response message. The DU 230b may transmit the UE context setup response message to the CU 210 over a point to point interface or via an API over an SBI. The UE context setup response message may confirm a setup of the UE context by the DU 230b.

At 520 and 525, the CU may perform a UE context setup procedure with the DU 230c. In particular, at 520 the CU 210 may transmit, and the DU 230c may receive, a UE context setup request message (e.g., over a point to point interface or via an API over an SBI). The UE context setup request message may indicate one or more bearers (e.g., one or more data radio bearers, one or more signaling radio bearers) associated with the third cell group for the DU 230c to establish with the UE 120 for that context, an indication of the third cell group for the DU 230c to support for communications between the UE 120 and the CU 210, an indication of whether the third cell group is active or deactivated (e.g., whether the cell group is an active cell group or a candidate cell group within the set of cell groups configured for the UE 120), and a cell group suitability indication associated with the third cell group. In the example 500, the UE context setup request message may indicate that the third cell group is a candidate cell group (e.g., is deactivated).

At 525, the DU 230c may transmit (e.g., over a point to point interface or via an API over an SBI), and the CU 210 may receive, a UE context setup response message. The UE context setup response message may confirm a setup of the UE context by the DU 230c.

At 530, the CU 210 may transmit (e.g., via the active cell group 1 associated with the DU 230a), and the UE 120 may receive, an indication of the one or more additional cell groups configured for the UE 120. The CU 210 may transmit the indication via the DU over a point to point interface or via an API over an SBI, and within an RRC reconfiguration message or an L2 command (e.g., a MAC-CE) or an L1 command. The indication of the one or more additional cell groups may include an indication of the additional cell groups configured for the UE 120 (e.g., the second cell group and the third cell group) and the cell group suitability indication associated with each cell group. That is, the indication may further indicate whether the CU 210 supports dual connectivity for the UE 120 via the second cell group (e.g., and not mobility procedures), whether the CU 210 supports mobility procedures for the UE 120 via the second cell group (e.g., and not dual connectivity), or whether the CU 210 supports both dual connectivity and mobility procedures for the UE 120 via the second cell group. Additionally, the indication may indicate whether the CU 210 supports dual connectivity for the UE 120 via the third cell group (e.g., and not mobility procedures), whether the CU 210 supports mobility procedures for the UE 120 via the third cell group (e.g., and not dual connectivity), or whether the CU 210 supports both dual connectivity and mobility procedures for the UE 120 via the third cell group.

Based on receiving the indication of the additional cell group configurations, the UE 120 may store the received candidate cell group configurations (e.g., the configurations for the candidate cell group 2 and the candidate cell group 3) and apply the configuration when the corresponding cell group is indicated as an active cell group.

At 535, the UE 120 may transmit (e.g., via the active cell group 1 associated with the DU 230a) an RRC reconfiguration complete message. The RRC reconfiguration complete message may indicate that the UE 120 has received the additional cell group configurations and stored the configurations for the candidate cell groups. The DU 230a may transmit the RRC reconfiguration complete message to the CU 210 over a point to point interface or via an API over an SBI.

As indicated above, FIG. 5 is provided as an example. Other examples may differ from what is described with respect to FIG. 5.

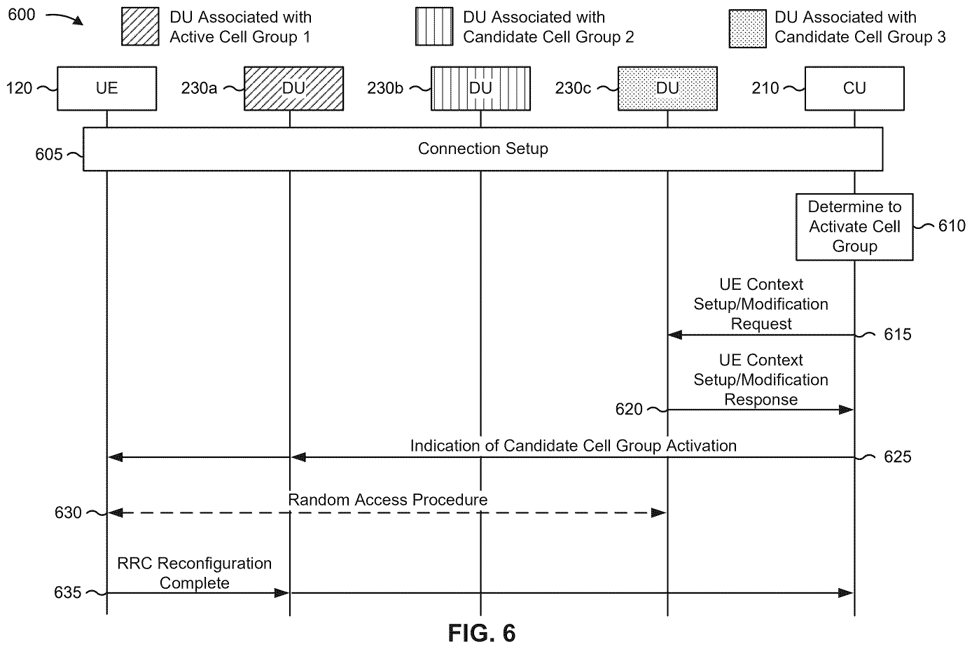

FIG. 6 is a diagram illustrating an example 600 associated with cell group configuration for dual connectivity and mobility procedures, in accordance with the present disclosure. In some cases, a UE 120 that performs the one or more operations illustrated with respect to the example 400 of FIG. 4 and example 500 of FIG. 5 may additionally perform the one or more operations illustrated with respect to the example 600 of FIG. 6. In particular, the example 600 illustrates one or more operations associated with a CU triggered mobility event (e.g., a CU triggered dual connectivity activation of the candidate cell group 3).

The UE 120, DUs 230, and CU 210 may correspond to the UE 120, DUs 230, and CU 210 described with reference to FIG. 5. In the example 600, the DU 230a may support a first cell group (e.g., the cell group 1), the DU 230b may support a second cell group (e.g., the cell group 2), and the DU 230c may support a third cell group (e.g., the cell group 3).

At 605, the CU 210 may perform a connection setup procedure with the UE 120. In some examples, the connection setup procedure at 605 may correspond to the operations described and illustrated with reference to FIG. 5. That is, after the connection setup procedure at 605, the UE 120 may have an established RRC connection with the CU 210 via a first active cell group associated with the DU 230a (e.g., the active cell group 1). Additionally, the UE 120 may be configured with two candidate cell groups: the candidate cell group 3 associated with the DU 230b, and the candidate cell group 3 associated with the DU 230c.

At 610, the CU 210 may determine to activate a cell group. For example, the CU 210 may determine to activate cell group 3 for dual connectivity of the UE 120 via the cell group 1 and the cell group 3 or for a mobility procedure of the UE 120 from the cell group 1 to the cell group 3. The CU 210 may decide to activate the cell group for the UE 120 based on a capability of the UE 120, a measurement performed by the UE 120 and reported to the CU 210 via the DU 230a (e.g., L1 measurements, L3 measurements), a measurement performed by a network node (e.g., the DU 230a, the DU 230b, the DU 230c, the CU 210), a service requirement associated with communications between the UE 120 and the network node 110, or another external trigger. In the example 600, the CU 210 may determine to activate the cell group 3 for the dual connectivity of the UE 120.

At 615, the CU 210 may transmit (e.g., over a point to point interface or via an API over an SBI), and the DU 230c may receive, a UE context setup request or a UE context modification request. In either case, the CU 210 may indicate, to the DU 230c (e.g., via the UE context setup request or via the UE context modification request) for the DU 230c to activate resources for the configured UE context. The UE context setup request or the UE context modification request may indicate, to the DU 230c, a cell group associated with the UE context that the DU 230c is to activate. In the example 600, the UE context setup or modification request may indicate for the DU 230c to activate the candidate cell group 3. The UE context setup or modification request message may additionally indicate whether the DU 230c is activating the candidate cell group 3 for dual connectivity or for a mobility procedure. In some cases, the UE context setup or modification request message may not include an indication of whether the DU 230c is activating the candidate cell group 3 for dual connectivity or for the mobility procedure if the candidate cell group 3 suitability indication does not indicate that the CU 210 supports both dual connectivity and mobility procedures via the candidate cell group 3. In some other cases, the UE context setup or modification request message may include the indication of whether the DU 230c is activating the candidate cell group 3 for dual connectivity or for the mobility procedure independent of the suitability indication associated with the candidate cell group 3. In the example 600, the CU 210 may indicate, within the UE context setup or modification request message, that the candidate cell group 3 activation is for dual connectivity.

At 620, the DU 230c may transmit, and the CU 210 may receive, a UE context setup response message. The DU 230c may transmit the UE context setup response message to the CU 210 over a point to point interface or via an API over an SBI. The UE context setup response message may confirm a setup of the UE context by the DU 230c.

At 625, the CU 210 may transmit, via the DU 230a and the active cell group 1, an indication of the candidate cell group 3 activation to the UE 120. The indication for the UE 120 to activate the cell group 3 may include an indication of whether the UE 120 is activating the cell group for dual connectivity with the CU 210 via the active cell group 1 and the candidate cell group 3 or for a mobility procedure of the UE 120 from the active cell group 1 to the candidate cell group 3. In the example 600, the indication of the candidate cell group 3 activation may indicate for the UE 120 to activate the cell group 3 for the dual connectivity of the UE 120. For example, the dual connectivity configuration may indicate for the UE 120 to support dual connectivity via the cell group 1 and the cell group 3. In some cases, the dual connectivity configuration may indicate for the UE 120 to support dual connectivity via the cell group 1 and the cell group 3 based on including the identifiers for the cell group 1 and the cell group 3. The CU 210 may transmit the indication of the candidate cell group 3 activation via an RRC reconfiguration message or via an L2 command (e.g., a MAC-CE) or L1 command. If the CU 210 transmits the indication of the candidate cell group 3 activation via an RRC reconfiguration message, the RRC reconfiguration message may correspond to an RRC transfer request that includes an indication for the UE 120 to activate the dual connectivity via the cell group 1 and the cell group 3.

At 630, the UE 120 may optionally perform a random access procedure with the DU 230c. That is, if the configuration associated with the cell group 3 does not configure an activation procedure of the cell group 3 without performing a random access procedure, the UE 120 may perform the random access procedure with the DU 230c to activate the cell group 3 at 630. Additionally, if the configuration associated with the cell group 3 does configure an activation procedure of the cell group 3 without performing the random access procedure, the UE 120 may refrain from performing the random access procedure with the DU 230c at 630.

At 635, the UE 120 may transmit (e.g., via the active cell group 1 associated with the DU 230a), an RRC reconfiguration complete message. That is, the UE 120 may transmit the RRC reconfiguration complete message to the DU 230a, and the DU 230a may transmit the RRC reconfiguration complete message to the CU 210 over a point to point interface or via an API over an SBI. The RRC reconfiguration complete message may correspond to an RRC transfer response message and may indicate that the UE 120 has completed an activation of the cell group indicated for the UE 120 to activate by the CU 210 at 625. In the example 600, the RRC reconfiguration complete message may indicate that the UE 120 has activated the candidate cell group 3.

As indicated above, FIG. 6 is provided as an example. Other examples may differ from what is described with respect to FIG. 6.

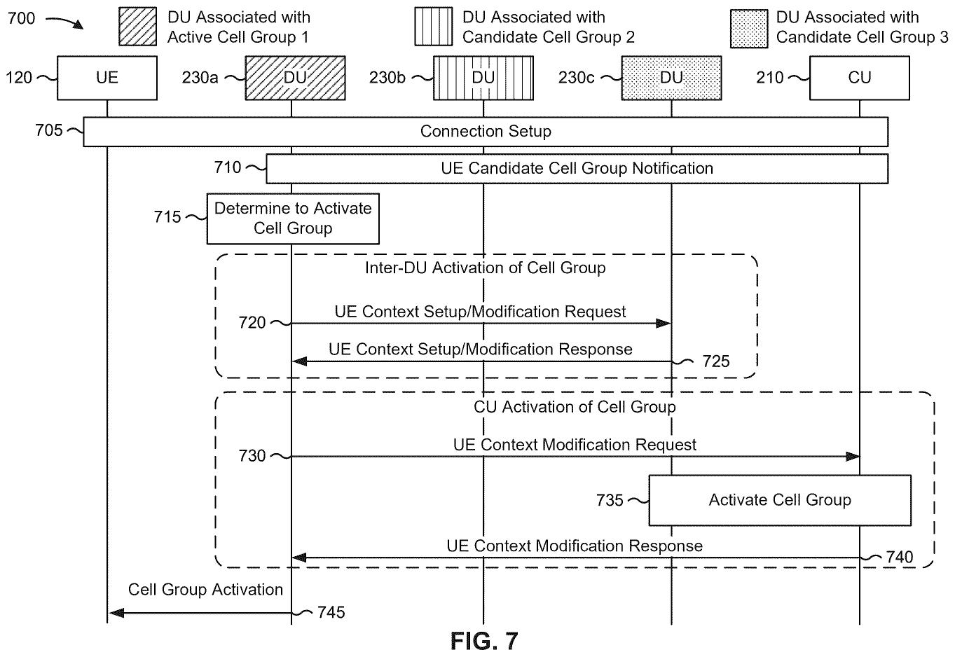

FIG. 7 is a diagram illustrating an example 700 associated with cell group configuration for dual connectivity and mobility procedures, in accordance with the present disclosure. In some cases, a UE 120 that performs the one or more operations illustrated with respect to the example 400 of FIG. 4 and example 500 of FIG. 5 may additionally perform the one or more operations illustrated with respect to the example 700 of FIG. 7. In particular, the example 700 illustrates one or more operations associated with a DU triggered mobility event (e.g., a DU triggered dual connectivity activation of the candidate cell group 3).

The UE 120, DUs 230, and CU 210 may correspond to the UE 120, DUs 230, and CU 210 described with reference to FIG. 5. In the example 700, the DU 230a may support a first cell group (e.g., the cell group 1), the DU 230b may support a second cell group (e.g., the cell group 2), and the DU 230c may support a third cell group (e.g., the cell group 3).

At 705, the CU 210 may perform a connection setup procedure with the UE 120. In some examples, the connection setup procedure at 705 may correspond to the operations described and illustrated with reference to FIG. 5. That is, after the connection setup procedure at 705, the UE 120 may have an established RRC connection with the CU 210 via a first active cell group associated with the DU 230a (e.g., the active cell group 1). Additionally, the UE 120 may be configured with two candidate cell groups: the candidate cell group 3 associated with the DU 230b, and the candidate cell group 3 associated with the DU 230c.

At 710, the CU 210 may provide an indication, to each of the one or more network nodes associated with active cell groups, of the candidate cell groups configured for the UE 120. In the example 700, at 710 the CU 210 may indicate, to the DU 230a (e.g., the DU 230a associated with the active cell group 1), the configurations of the candidate cell group 2 and the candidate cell group 3. The CU 210 may additionally indicate one or more criteria associated with activating the candidate cell groups for the UE 120. For example, the CU 210 may indicate one or more conditions for activating a cell group for dual connectivity or one or more conditions for activating a cell group for a mobility procedure (e.g., a handover procedure).

At 715, the DU 230a may determine to activate a candidate cell group of the UE 120. For example, the DU 230a may determine to either active a candidate cell group for a dual connectivity of the UE 120 or for a mobility procedure of the UE 120 (e.g., from the active cell group 1 to a candidate cell group). The DU 230a may decide whether to activate the candidate cell group for the UE 120 (e.g., for the dual connectivity or for the mobility procedure) based on a measurement performed by the UE 120 and reported to the DU 230a (e.g., an L1 measurement, an L3 measurement). Additionally, or alternatively, the DU 230a may determine to activate the candidate cell group for the UE 120 based on a condition associated with the dual connectivity activation being satisfied or based on a condition associated with the mobility procedure being satisfied. For example, the CU 210 may indicate, to the DU 230a, a threshold associated with dual connectivity activation via one of the candidate cell groups for the UE 120, or a threshold associated with a mobility procedure from the active cell group 1 to a candidate cell group. Here, the CU 210 may configure the DU 230a to activate a candidate cell group for the dual connectivity for the UE 120 via a candidate cell group of the UE 120 (e.g., via the candidate cell group 2 or the candidate cell group 3) if the threshold associated with the dual connectivity is satisfied. Additionally, the CU 210 may configure the DU 230a to activate a candidate cell group for the mobility procedure from the active cell group 1 to a candidate cell group if the threshold associated with the mobility procedure is satisfied. The thresholds may correspond to a traffic load threshold (e.g., an amount of traffic load allowed to be handled by the DU 230a prior to the DU 230a triggering the activation of dual connectivity for the UE 120), a signal metric threshold (e.g., a minimum reported L1 measurement), or some other type of threshold. In the example 700, the DU 230a may determine to activate the candidate cell group 3 for the dual connectivity of the UE 120 at 715.

Based on determining to activate cell group 3, the DU 230a may perform an inter-DU activation of the cell group (e.g., as illustrated and described with reference to 720 and 725) or the DU 230a may initiate a CU activation of the cell group (e.g., as described and illustrated with reference to 730, 735, and 740).

At 720 and 725, the DU 230a may perform the inter-DU activation of the cell group based on determining to activate the candidate cell group at 715. At 720, the DU 230a may transmit, and the DU 230c may receive, a UE context setup or modification request (e.g., via an inter-DU API). The UE context setup or modification request may indicate for the DU 230c to activate resources for the configured UE context. The UE context setup or modification request may indicate, to the DU 230c, a cell group associated with the UE context that the DU 230c is to activate. In the example 700, the UE context setup or modification request may indicate for the DU 230c to activate the candidate cell group 3. The UE context setup or modification request message May additionally indicate whether the DU 230c is activating the candidate cell group 3 for dual connectivity or for a mobility procedure. In the example 700, the DU 230a may indicate, within the UE context setup or modification request message, that the candidate cell group 3 activation is for dual connectivity. At 725, the DU 230c may transmit, and the DU 230a may receive, a UE context setup response message. The DU 230c may transmit the UE context setup response message to the DU 230a via an inter-DU API. The UE context setup response message may confirm a setup of the UE context by the DU 230c. Based on performing the inter-DU activation of the cell group, the DU 230a may proceed to 745.

At 730, 735, and 740, the DU 230a and the DU 230c and the CU 210 may perform a DU-triggered CU activation of the cell group. At 730, the DU 230a may transmit, and the CU 210 may receive (e.g., over a point to point interface or via an API over an SBI), a UE context modification request indicating a request for the CU 210 to activate the candidate cell group 3. That is, the DU 230a may indicate, to the CU 210, the selected candidate cell group (e.g., the candidate cell group 3) and whether the candidate cell group is being requested to be activated for dual connectivity or for a mobility procedure. In the example 700, the UE context modification request may indicate that the selected candidate cell group is being requested to be activated for the dual connectivity of the UE 120. In some cases, the UE context modification request message may correspond to a UE context modification required request message. At 735, the CU 210 may perform a UE context setup or modification procedure with the DU 230c to activate the cell group 3. That is, based on receiving the UE context modification request message from the DU 230a indicating the request for the CU 210 to activate the cell group 3, the CU 210 may activate the cell group 3 at 735. The CU 210 may activate the cell group for either the mobility procedure or for the dual connectivity, in accordance with the indication within the UE context modification request message. In the example 700, the CU 210 may activate the cell group 3 for the dual connectivity of the UE 120. At 740 the CU 210 may transmit, and the DU 230a may receive (e.g., over a point to point interface or via an API over an SBI), a UE context setup response message that confirms a setup of the UE context by the DU 230c. The UE context setup response message may indicate the one or more candidate cell groups that have been successfully activated (e.g., the candidate cell group 3) in response to the UE context modification request transmitted by the DU 230a at 730. The UE context modification response message may additionally indicate whether the one or more candidate cells that have been successfully activated have been successfully activated for dual connectivity or for a mobility procedure. For example, the UE context modification response may include an indication that the candidate cell group 3 is successfully activated for dual connectivity for the UE 120.

At 745, the DU 230a may transmit a cell group activation command to the UE 120. The cell group activation command may indicate for the UE 120 to activate the cell group 3. The cell group activation command may additionally indicate whether the UE 120 is to activate the cell group for the dual connectivity or a mobility procedure. Accordingly, the UE 120 may apply to portions of the configuration for the indicated cell group that are applicable for the dual connectivity or the mobility procedure. In the example 700, the cell group activation command may indicate for the UE 120 to activate dual connectivity with the CU 210 via the active cell group 1 and the candidate cell group 3. For example, the dual connectivity configuration may indicate for the UE 120 to activate both the cell group 1 and the cell group 3. In some cases, the dual connectivity configuration may indicate for the UE 120 to activate both the cell group 1 and the cell group 3 based on including the identifiers for the cell group 1 and the cell group 3. The CU 210 may transmit the cell group activation command via an L2 command (e.g., a MAC-CE).

Based on receiving the cell group activation command, the UE 120 may apply a full or partial configuration for the cell groups indicated as active (e.g., the cell group 1 and the cell group 3). That is, the UE 120 may refrain from applying one or more portions of the configuration for the activated cell group that are not specific to dual connectivity or a mobility procedure (e.g., in accordance with whether the cell group is activated for the dual connectivity or the mobility procedure). In the example 700, the UE may apply the portions of the configuration for the activated cell group 3 that are for dual connectivity. Additionally, if the configuration associated with the cell group 3 does not configure an activation procedure of the cell group 3 without performing a random access procedure, the UE 120 may perform the random access procedure with the DU 230c to activate the cell group 3. Additionally, if the configuration associated with the cell group 3 does configure an activation procedure of the cell group 3 without performing the random access procedure, the UE 120 may refrain from performing the random access procedure with the DU 230c.

As indicated above, FIG. 7 is provided as an example. Other examples may differ from what is described with respect to FIG. 7.

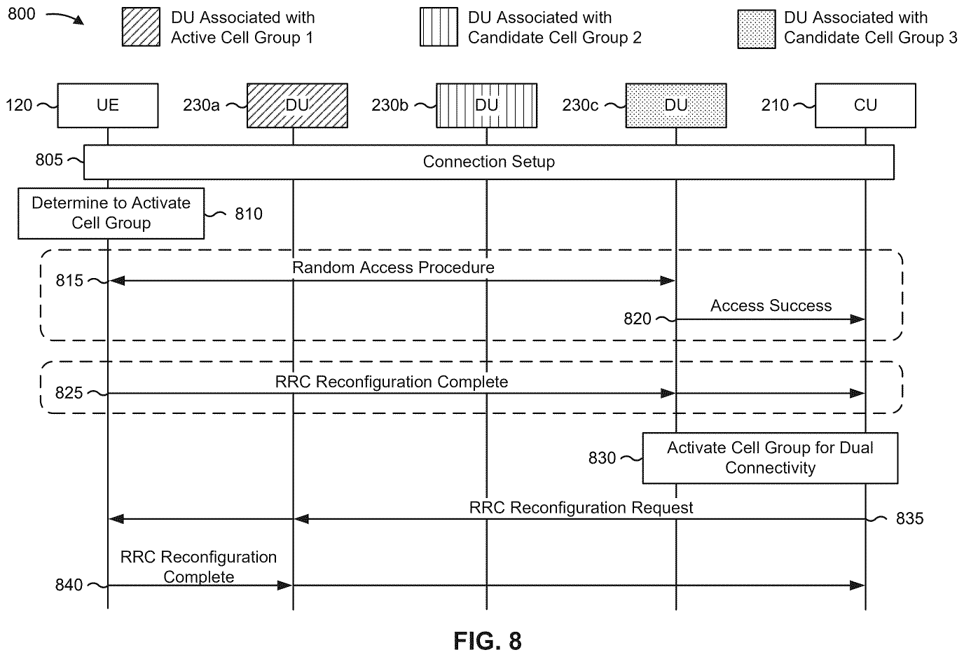

FIG. 8 is a diagram illustrating an example 800 associated with cell group configuration for dual connectivity and mobility procedures, in accordance with the present disclosure. In some cases, a UE 120 that performs the one or more operations illustrated with respect to the example 400 of FIG. 4 and example 500 of FIG. 5 may additionally perform the one or more operations illustrated with respect to the example 800 of FIG. 8. In particular, the example 800 illustrates one or more operations associated with a UE triggered mobility event (e.g., a UE triggered dual connectivity activation of the candidate cell group 3).

The UE 120, DUs 230, and CU 210 may correspond to the UE 120, DUs 230, and CU 210 described with reference to FIG. 5. In the example 800, the DU 230a may support a first cell group (e.g., the cell group 1), the DU 230b may support a second cell group (e.g., the cell group 2), and the DU 230c may support a third cell group (e.g., the cell group 3).

At 805, the CU 210 may perform a connection setup procedure with the UE 120. In some examples, the connection setup procedure at 805 may correspond to the operations described and illustrated with reference to FIG. 5. That is, after the connection setup procedure at 805, the UE 120 may have an established RRC connection with the CU 210 via a first active cell group associated with the DU 230a (e.g., the active cell group 1). Additionally, the UE 120 may be configured with two candidate cell groups: the candidate cell group 3 associated with the DU 230b, and the candidate cell group 3 associated with the DU 230c.

At 810, the UE 120 may determine to activate the cell group 3. In some cases, the UE 120 may determine to activate the cell group 3 for either dual connectivity or for a mobility procedure. The UE 120 may decide to activate the cell group 3 based on a measurement performed by the UE 120 (e.g., an L1 measurement, an L3 measurement). Additionally, or alternatively, the UE 120 may determine to activate the cell group 3 for the UE 120 based on a condition associated with the dual connectivity activation or a condition associated with the mobility procedure being satisfied. For example, the CU 210 may indicate, to the UE 120, a threshold associated with dual connectivity activation via one of the candidate cell groups for the UE 120 or a threshold associated with a mobility procedure via one of the candidate cell groups. Here, the CU 210 may configure the UE 120 to activate the dual connectivity or perform the mobility procedure via a candidate cell group of the UE 120 (e.g., via the candidate cell group 2 or the candidate cell group 3) if the threshold is satisfied. The threshold May correspond to a traffic load threshold (e.g., an amount of traffic load allowed to be handled by the DU 230a prior to the UE 120 triggering the activation of dual connectivity for the UE 120), a signal metric threshold (e.g., a minimum L1 measurement), or some other type of threshold. In the example 800, the UE 120 may determine to activate the cell group 3 for the dual connectivity of the UE 120 via the cell group 1 and the cell group 3.

Based on determining to activate the dual connectivity for the UE 120 via the active cell group 1 and the candidate cell group 3, the UE 120 may activate the bearers on each cell group for the dual connectivity (e.g., on the cell group 1 and the cell group 3) based on a configuration provided to the UE 120 by the CU 210. For example, the UE 120 may activate the bearers on the candidate cell group 3 in accordance with a configuration provided to the UE 120 by the CU 210 for the candidate cell group 3.

After determining that a condition associated with triggering an activation of the cell group 3 has been satisfied, the UE 120 may indicate, to the CU 210, whether the condition is associated with dual connectivity or a mobility procedure (e.g., a handover procedure). That is, the UE 120 may indicate whether the activation of the cell group 3 is for dual connectivity or a mobility procedure. In one example, the UE 120 may indicate whether the activation of the cell group 3 is for dual connectivity or a mobility procedure via a random access procedure, as illustrated and described with reference to 815 and 820. In another example, the UE 120 may indicate whether the activation of the cell group 3 is for dual connectivity or a mobility procedure via an RRC reconfiguration complete message, as described and illustrated with reference to 825. In some cases, the UE 120 may indicate whether the activation of the cell group 3 is for dual connectivity or the mobility procedure via the RRC reconfiguration complete message (e.g., instead of via the random access procedure) if an activation configuration of the cell group 3 enables the activation of the cell group 3 without the random access procedure. Accordingly, the UE 120 may either perform the operations described with reference to 815 and 820 or the operations described with reference to 825.

At 815, the UE 120 may perform a random access procedure with the DU 230c that is associated with the candidate cell group 3 identified for activation by the UE 120 at 810. The UE 120 may indicate, to the DU 230c (e.g., within one of the messages transmitted from the UE 120 to the DU 230c as part of the random access procedure), a type of mobility event associated with activating the candidate cell group 3. That is, the UE 120 may indicate that the activation of the candidate cell group 3 is for a dual connectivity of the UE 120 or for a mobility procedure (e.g., handover) of the UE 120. In the example 800, the UE 120 may indicate that the type of mobility event is the dual connectivity of the UE 120. At 820, the DU 230c may transmit, and the CU 210 may receive, an access success message over a point to point interface or via an API over an SBI. The access success message may include an indication of a type of connectivity event (e.g., dual connectivity, a mobility procedure such as a handover) associated with activating the cell group associated with the DU 230c (e.g., the cell group 3). In the example 800, the access success message may indicate that activating the cell group is for dual connectivity.

At 825, the UE 120 may transmit an RRC reconfiguration complete message to the CU 210 via the DU 230c (e.g., over a point to point interface or via an API over an SBI). The RRC reconfiguration complete message may correspond to an RRC transfer request and may indicate whether the activation of the cell group 3 is for dual connectivity or for a mobility procedure. In the example 800, the RRC reconfiguration complete message may indicate that the activation of the cell group 3 is for the mobility procedure.

At 830, the CU 210 may perform a UE context setup or modification procedure with the DU 230c to activate the cell group 3. That is, based on receiving the indication that the activation of cell group 3 is for the dual connectivity of the UE 120 (e.g., via an access success message or via an RRC reconfiguration complete message), the CU 210 may activate the cell group 3 for the dual connectivity of the UE 120. For example, the CU 210 may activate the bearer resources for dual connectivity on the DU 230c cell group 3.

At 835, the CU 210 may transmit, via the DU 230a and the active cell group 1, an RRC reconfiguration message. The RRC reconfiguration message may include an indication for the UE 120 to activate dual connectivity with the CU 210 via the active cell group 1 and the candidate cell group 3. In some cases, the RRC reconfiguration message may indicate a modification of the dual connectivity configuration for the UE 120.

At 840, the UE 120 may transmit (e.g., via the active cell group 1 associated with the DU 230a), an RRC reconfiguration complete message. That is, the UE 120 may transmit the RRC reconfiguration complete message to the DU 230a, and the DU 230a may transmit the RRC reconfiguration complete message to the CU 210 over a point to point interface or via an API over an SBI. The RRC reconfiguration complete message may correspond to an RRC transfer response message and may indicate that the UE 120 has completed an activation of the cell group indicated by the RRC reconfiguration request or has completed a modification of the dual connectivity configuration indicated by the RRC reconfiguration request. In the example 800, the RRC reconfiguration complete message may indicate that the UE 120 has activated the candidate cell group 3.

As indicated above, FIG. 8 is provided as an example. Other examples may differ from what is described with respect to FIG. 8.

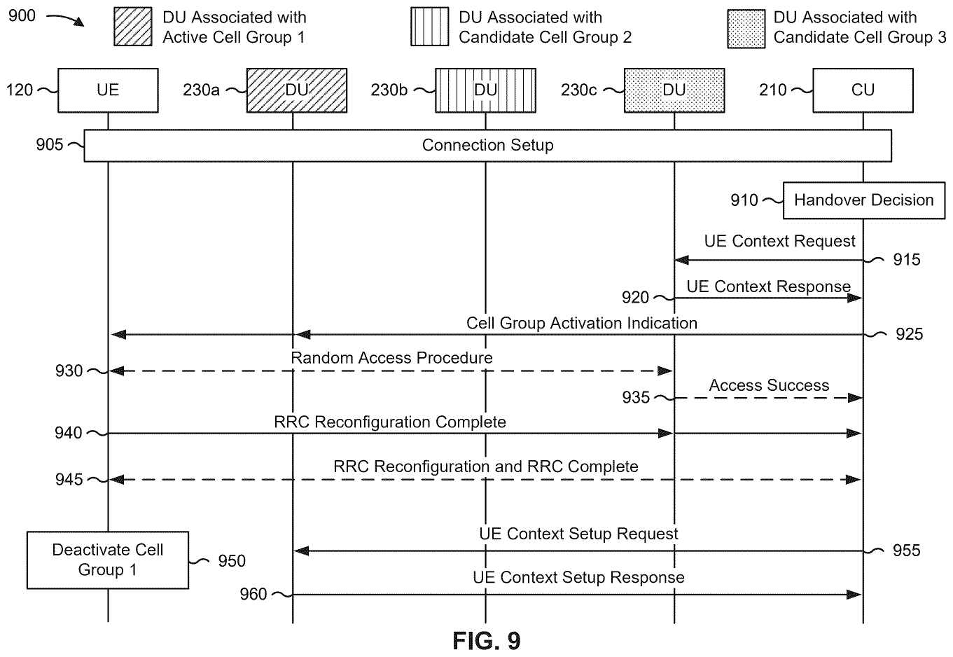

FIG. 9 is a diagram illustrating an example 900 associated with cell group configuration for dual connectivity and mobility procedures, in accordance with the present disclosure. In some cases, a UE 120 that performs the one or more operations illustrated with respect to the example 400 of FIG. 4 and example 500 of FIG. 5 may additionally perform the one or more operations illustrated with respect to the example 900 of FIG. 9. In particular, the example 900 illustrates one or more operations associated with a CU triggered mobility event (e.g., a CU triggered handover from the active cell group 1 to the candidate cell group 3).

The UE 120, DUs 230, and CU 210 may correspond to the UE 120, DUs 230, and CU 210 described with reference to FIG. 5. In the example 900, the DU 230a may support a first cell group (e.g., the cell group 1), the DU 230b may support a second cell group (e.g., the cell group 2), and the DU 230c may support a third cell group (e.g., the cell group 3).

At 905, the CU 210 may perform a connection setup procedure with the UE 120. In some examples, the connection setup procedure at 905 may correspond to the operations described and illustrated with reference to FIG. 5. That is, after the connection setup procedure at 905, the UE 120 may have an established RRC connection with the CU 210 via a first active cell group associated with the DU 230a (e.g., the active cell group 1). Additionally, the UE 120 may be configured with two candidate cell groups: the candidate cell group 3 associated with the DU 230b, and the candidate cell group 3 associated with the DU 230c.

At 910, the CU 210 may determine to perform a handover of the UE 120 from the active cell group 1 to the candidate cell group 3. For example, the CU 210 may determine to activate cell group 3 for a mobility procedure of the UE 120. The CU 210 may decide to activate the cell group for the UE 120 based on a capability of the UE 120, a measurement performed by the UE 120 and reported to the CU 210 via the DU 230a (e.g., L1 measurements, L3 measurements), a measurement performed by a network node (e.g., the DU 230a, the DU 230b, the DU 230c, the CU 210), a service requirement associated with communications between the UE 120 and the network node 110, or another external trigger.

At 915, the CU 210 may transmit (e.g., over a point to point interface or via an API over an SBI), and the DU 230c may receive, a UE context setup request or a UE context modification request. In either case, the CU 210 may indicate, to the DU 230c (e.g., via the UE context setup request or via the UE context modification request) for the DU 230c to activate resources for the configured UE context. The UE context setup request or the UE context modification request may indicate, to the DU 230c, a cell group associated with the UE context that the DU 230c is to activate. In the example 900, the UE context setup or modification request may indicate for the DU 230c to activate the candidate cell group 3. The UE context setup or modification request message may additionally indicate whether the DU 230c is activating the candidate cell group 3 for dual connectivity or for a mobility procedure. In the example 900, the CU 210 may indicate, within the UE context setup or modification request message, that the candidate cell group 3 activation is for a mobility procedure of the UE 120 (e.g., for a handover).

At 920, the DU 230c may transmit, and the CU 210 may receive, a UE context setup response message. The DU 230c may transmit the UE context setup response message to the CU 210 over a point to point interface or via an API over an SBI. The UE context setup response message may confirm a setup of the UE context by the DU 230c.

At 925, the CU 210 may transmit, via the DU 230a and the active cell group 1, an indication for the UE 120 to active a candidate cell group. In the example 900, the indication may indicate for the UE 120 to activate the candidate cell group 3. The indication for the UE 120 to activate the cell group may additionally include an indication of whether the UE 120 is activating the cell group for dual connectivity or for a mobility procedure. In the example 900, the CU 210 may indicate for the UE 120 to activate the cell group 3 for a mobility procedure of the UE 120 from the active cell group 1 to the candidate cell group 3. In some cases, the mobility procedure of the UE 120 may correspond to a make-before-break handover of the UE 120. That is, the indication for the UE 120 to activate the candidate cell group 3 may indicate for the UE 120 to activate the cell group 3 and conditionally release the cell group 1 (e.g., based on a success of the activation of the cell group 3). The CU 210 may transmit the indication of the candidate cell group 3 activation via an RRC reconfiguration message or via an L2 command (e.g., a MAC-CE).

At 930, the UE 120 may optionally perform a random access procedure with the DU 230c. That is, if the configuration associated with the cell group 3 does not configure an activation procedure of the cell group 3 without performing a random access procedure, the UE 120 may perform the random access procedure with the DU 230c to activate the cell group 3 at 930. Additionally, if the configuration associated with the cell group 3 does configure an activation procedure of the cell group 3 without performing the random access procedure, the UE 120 may refrain from performing the random access procedure with the DU 230c at 930. If the UE 120 performs the random access procedure with the DU 230c, the UE 120 may indicate, to the DU 230c (e.g., within one of the messages transmitted from the UE 120 to the DU 230c as part of the random access procedure), a type of mobility event associated with activating the candidate cell group 3. That is, the UE 120 may indicate that the activation of the candidate cell group 3 is for a mobility procedure (e.g., a make-before-break handover) of the UE 120. At 935, the DU 230c may transmit, and the CU 210 may receive, an access success message over a point to point interface or via an API over an SBI. The access success message may include an indication of a type of connectivity event (e.g., dual connectivity, a mobility procedure such as a handover) associated with activating the cell group associated with the DU 230c (e.g., the cell group 3). In the example 900, the access success message may indicate that activating the cell group is for a mobility procedure (e.g., a make-before-break handover).

At 940, the UE 120 may transmit (e.g., via the active cell group 3 associated with the DU 230c), an RRC reconfiguration complete message. That is, the UE 120 may transmit the RRC reconfiguration complete message to the DU 230c, and the DU 230c may transmit the RRC reconfiguration complete message to the CU 210 over a point to point interface or via an API over an SBI. The RRC reconfiguration complete message may correspond to an RRC transfer response message and may indicate that the UE 120 has completed an activation of the cell group indicated for the UE 120 to activate by the CU 210 at 925. In the example 900, the RRC reconfiguration complete message may indicate that the UE 120 has activated the candidate cell group 3. The RRC reconfiguration complete message may additionally indicate whether the activated cell group 3 is activated for the dual connectivity or the mobility procedure. In the example 900, the UE 120 may indicate, within the RRC reconfiguration complete message, that the cell group 3 is activated for the make-before-break handover of the UE 120.

At 945, the UE 120 may optionally exchange RRC reconfiguration and RRC reconfiguration complete messages with the CU 210. For example, the CU 210 may configure the UE 120 to transition the cell group 1 to the cell group 3 via an RRC reconfiguration request message. Additionally, or alternatively, the CU 210 may configure the UE 120 to release the cell group 1 via an RRC reconfiguration request message. Based on receiving the RRC reconfiguration request message, the UE 120 may transmit an RRC complete message to the CU 210 indicating a completion of the reconfiguration indicated in the RRC reconfiguration request message (e.g., indicating a completion of the UE 120 transitioning the cell group 1 to the cell group 3, indicating a completion of the deactivation of the cell group 1).

For the make-before-break handover, the UE 120 may deactivate or release the source cell group (e.g., the cell group 1) based on a successful setup of the cell group 3 or based on receiving an indication to deactivate or release the source cell group (e.g., from the CU 210). In either case, at 950, the UE 120 may deactivate the source cell group (e.g., the cell group 1) based on the setup of the cell group 3 being successful.

At 955, the CU 210 may transmit (e.g., over a point to point interface or via an API over an SBI), and the DU 230a may receive, a UE context setup or modification request that indicates, to the DU 230a for the DU 230a deactivate resources for the configured UE context. The UE context setup or modification request may indicate, to the DU 230a, a cell group associated with the UE context that the DU 230a is to deactivate. In the example 900, the UE context setup or modification request may indicate for the DU 230a to deactivate the cell group 1.

At 960, the DU 230a may transmit, and the CU 210 may receive, a UE context setup or modification response message. The DU 230a may transmit the UE context setup or modification response message to the CU 210 over a point to point interface or via an API over an SBI. The UE context setup or modification response message may confirm a deactivation of the UE context by the DU 230a.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with cell group configuration for dual connectivity and mobility procedures.

As shown in FIG. 10, in some aspects, process 1000 may include establishing a first RRC connection with a network node via a first cell group (block 1010). For example, the UE (e.g., using communication manager 1206, depicted in FIG. 12) may establish a first RRC connection with a network node via a first cell group, as described above.

As further shown in FIG. 10, in some aspects, process 1000 may include receiving signaling indicating a configuration for a second cell group, wherein the configuration comprises an indication of whether the network node supports dual connectivity for the UE via the second cell group, whether the network node supports a mobility procedure for the UE via the second cell group, or both (block 1020). For example, the UE (e.g., using reception component 1202 and/or communication manager 1206, depicted in FIG. 12) may receive signaling indicating a configuration for a second cell group, wherein the configuration comprises an indication of whether the network node supports dual connectivity for the UE via the second cell group, whether the network node supports a mobility procedure for the UE via the second cell group, or both, as described above.

As further shown in FIG. 10, in some aspects, process 1000 may include establishing, with the network node via the second cell group, a second RRC connection for the dual connectivity or for the mobility procedure based at least in part on whether the network node supports the dual connectivity, the mobility procedure, or both via the second cell group (block 1030). For example, the UE (e.g., using communication manager 1206, depicted in FIG. 12) may establish, with the network node via the second cell group, a second RRC connection for the dual connectivity or for the mobility procedure based at least in part on whether the network node supports the dual connectivity, the mobility procedure, or both via the second cell group, as described above.

Process 1000 may include additional aspects, such as any single aspect or any combination of aspects described below and/or in connection with one or more other processes described elsewhere herein.

In a first aspect, the configuration for the second cell group further comprises one or more signaling radio bearer and data radio bearer configurations associated with one or more layers of a protocol stack of the UE, an indication of one or more portions of the configuration that apply to the second RRC connection established for the dual connectivity, an indication of one or more portions of the configuration that apply to the second RRC connection established for the mobility procedure, a first condition associated with establishing the second RRC connection for the dual connectivity, or a second condition associated with establishing the second RRC connection for the mobility procedure.

In a second aspect, alone or in combination with the first aspect, process 1000 includes applying a portion of the configuration for the second cell group to the second RRC connection, wherein the portion of the configuration that is applied is based at least in part on whether the second RRC connection is established for the dual connectivity or for the mobility procedure.

In a third aspect, alone or in combination with one or more of the first and second aspects, establishing the second RRC connection comprises establishing the second RRC connection for the dual connectivity.

In a fourth aspect, alone or in combination with one or more of the first through third aspects, the dual connectivity is triggered by a central unit associated with the network node, a distributed unit associated with the network node, or the UE.

In a fifth aspect, alone or in combination with one or more of the first through fourth aspects, establishing the second RRC connection comprises establishing the second RRC connection for the mobility procedure.

In a sixth aspect, alone or in combination with one or more of the first through fifth aspects, process 1000 includes transmitting, to the network node via the second RRC connection, a message indicating a successful establishment of the second RRC connection, wherein the message further comprises an indication establishing that the second RRC connection is for the mobility procedure, and releasing the first RRC connection based at least in part on successfully establishing the second RRC connection.

In a seventh aspect, alone or in combination with one or more of the first through sixth aspects, process 1000 includes receiving, from the network node via the second RRC connection, an indication to release the first RRC connection, wherein releasing the first RRC connection is based at least in part on receiving the indication to release the first RRC connection.

In an eighth aspect, alone or in combination with one or more of the first through seventh aspects, process 1000 includes receiving, from the network node via the first RRC connection, signaling indicating for the UE to establish the second RRC connection and release the first RRC connection after successfully establishing the second RRC connection, wherein establishing the second RRC connection is based at least in part on receiving the signaling indicating for the UE to establish the second RRC connection.

In a ninth aspect, alone or in combination with one or more of the first through eighth aspects, process 1000 includes receiving, via the first RRC connection, a MAC-CE indicating for the UE to perform the mobility procedure, wherein establishing the second RRC connection is based at least in part on receiving the MAC-CE.

In a tenth aspect, alone or in combination with one or more of the first through ninth aspects, the mobility procedure is triggered by a central unit associated with the network node, a distributed unit associated with the network node, or the UE.

In an eleventh aspect, alone or in combination with one or more of the first through tenth aspects, the mobility procedure comprises a first handover procedure with a random access procedure, a make-before-break handover procedure, a conditional handover procedure, or a second handover procedure without a random access procedure.

In a twelfth aspect, alone or in combination with one or more of the first through eleventh aspects, process 1000 includes receiving, from the network node, a command for the UE to establish the second RRC connection, wherein establishing the second RRC connection is based at least in part on the command.

In a thirteenth aspect, alone or in combination with one or more of the first through twelfth aspects, the command comprises an RRC configuration message, an RRC reconfiguration message, a MAC-CE, or an L1 command.

In a fourteenth aspect, alone or in combination with one or more of the first through thirteenth aspects, process 1000 includes determining that a first condition associated with the dual connectivity or a second condition associated with the mobility procedure is satisfied, wherein establishing the second RRC connection is based at least in part on the first condition or the second condition being satisfied.

In a fifteenth aspect, alone or in combination with one or more of the first through fourteenth aspects, process 1000 includes transmitting, via random access control channel signaling, via an RRC setup complete message, or via an RRC reconfiguration complete message, an indication of whether the first condition associated with the dual connectivity or the second condition associated with the mobility procedure is satisfied.

In a sixteenth aspect, alone or in combination with one or more of the first through fifteenth aspects, the signaling indicating the configuration for the second cell group comprises an RRC reconfiguration message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with cell group configuration for dual connectivity and mobility procedures.

As shown in FIG. 11, in some aspects, process 1100 may include establishing a first RRC connection with a UE via a first cell group (block 1110). For example, the network node (e.g., using communication manager 1306, depicted in FIG. 13) may establish a first RRC connection with a UE via a first cell group, as described above.

As further shown in FIG. 11, in some aspects, process 1100 may include transmitting signaling indicating a configuration for a second cell group, wherein the configuration comprises an indication of whether the network node supports dual connectivity for the UE via the second cell group, whether the network node supports a mobility procedure for the UE via the second cell group, or both (block 1120). For example, the network node (e.g., using transmission component 1304 and/or communication manager 1306, depicted in FIG. 13) may transmit signaling indicating a configuration for a second cell group, wherein the configuration comprises an indication of whether the network node supports dual connectivity for the UE via the second cell group, whether the network node supports a mobility procedure for the UE via the second cell group, or both, as described above.

As further shown in FIG. 11, in some aspects, process 1100 may include establishing, with the UE via the second cell group, a second RRC connection for the dual connectivity or for the mobility procedure based at least in part on whether the network node supports the dual connectivity, the mobility procedure, or both via the second cell group (block 1130). For example, the network node (e.g., using communication manager 1306, depicted in FIG. 13) may establish, with the UE via the second cell group, a second RRC connection for the dual connectivity or for the mobility procedure based at least in part on whether the network node supports the dual connectivity, the mobility procedure, or both via the second cell group, as described above.

Process 1100 may include additional aspects, such as any single aspect or any combination of aspects described below and/or in connection with one or more other processes described elsewhere herein.

In a first aspect, process 1100 includes transmitting, from a central unit associated with the network node to a distributed unit associated with the network node, signaling indicating whether the network node supports dual connectivity for the UE via the second cell group, whether the network node supports a mobility procedure for the UE via the second cell group, or both.

In a second aspect, alone or in combination with the first aspect, the configuration for the second cell group further comprises one or more signaling radio bearer and data radio bearer configurations associated with one or more layers of a protocol stack of the UE, an indication of one or more portions of the configuration that apply to the second RRC connection established for the dual connectivity, an indication of one or more portions of the configuration that apply to the second RRC connection established for the mobility procedure, a first condition associated with establishing the second RRC connection for the dual connectivity, or a second condition associated with establishing the second RRC connection for the mobility procedure.

In a third aspect, alone or in combination with one or more of the first and second aspects, process 1100 includes applying a portion of the configuration for the second cell group to the second RRC connection, wherein the portion of the configuration that is applied is based at least in part on whether the second RRC connection is established for the dual connectivity or for the mobility procedure.

In a fourth aspect, alone or in combination with one or more of the first through third aspects, process 1100 includes transmitting, from a distributed unit associated with the network node to a central unit associated with the network node, signaling indicating whether the second RRC connection is for the dual connectivity or for the mobility procedure.

In a fifth aspect, alone or in combination with one or more of the first through fourth aspects, process 1100 includes receiving, by the distributed unit associated with the network node from the UE via random access control channel signaling, an indication of whether the second RRC connection is for the dual connectivity or for the mobility procedure, wherein transmitting the signaling to the central unit associated with the network node comprises transmitting the signaling via an access success message.

In a sixth aspect, alone or in combination with one or more of the first through fifth aspects, establishing the second RRC connection comprises establishing the second RRC connection for the dual connectivity.

In a seventh aspect, alone or in combination with one or more of the first through sixth aspects, the dual connectivity is triggered by a central unit associated with the network node, a distributed unit associated with the network node, or the UE.

In an eighth aspect, alone or in combination with one or more of the first through seventh aspects, establishing the second RRC connection comprises establishing the second RRC connection for the mobility procedure.

In a ninth aspect, alone or in combination with one or more of the first through eighth aspects, process 1100 includes receiving, from the UE via the second RRC connection, a message indicating a successful establishment of the second RRC connection, wherein the message further comprises an indication establishing that the second RRC connection is for the mobility procedure.

In a tenth aspect, alone or in combination with one or more of the first through ninth aspects, process 1100 includes transmitting, to the UE via the second RRC connection, an indication to release the first RRC connection based at least in part on receiving the message indicating the successful establishment of the second RRC connection.

In an eleventh aspect, alone or in combination with one or more of the first through tenth aspects, process 1100 includes transmitting, to the UE via the first RRC connection, signaling indicating for the UE to establish the second RRC connection and release the first RRC connection after successfully establishing the second RRC connection, wherein establishing the second RRC connection is based at least in part on transmitting the signaling indicating for the UE to establish the second RRC connection.

In a twelfth aspect, alone or in combination with one or more of the first through eleventh aspects, process 1100 includes transmitting, to the UE by a distributed unit associated with the network node via the first RRC connection, a MAC-CE or an L1 command indicating for the UE to perform the mobility procedure, wherein establishing the second RRC connection is based at least in part on transmitting the MAC-CE.

In a thirteenth aspect, alone or in combination with one or more of the first through twelfth aspects, the distributed unit is associated with the first cell group, the method further comprising transmitting an indication for the second distributed unit to activate the second cell group for the mobility procedure, wherein establishing the second RRC connection is based at least in part on the indication to activate the second cell group.

In a fourteenth aspect, alone or in combination with one or more of the first through thirteenth aspects, process 1100 includes transmitting, from the distributed unit associated with the network node to a central unit associated with the network node, an indication for the central unit to activate the second cell group for the mobility procedure, wherein establishing the second RRC connection is based at least in part on the central unit activating the second cell group for the mobility procedure.

In a fifteenth aspect, alone or in combination with one or more of the first through fourteenth aspects, transmitting the MAC-CE or the L1 command to the UE indicating for the UE to perform the mobility procedure is based at least in part on a measurement report received by the distributed unit from the UE, load conditions associated with the network node, or a condition associated with the mobility procedure being satisfied.

In a sixteenth aspect, alone or in combination with one or more of the first through fifteenth aspects, the mobility procedure is triggered by a central unit associated with the network node, a distributed unit associated with the network node, or the UE.

In a seventeenth aspect, alone or in combination with one or more of the first through sixteenth aspects, the mobility procedure comprises a first handover procedure with a random access procedure, a make-before-break handover procedure, a conditional handover procedure, or a second handover procedure without a random access procedure.

In an eighteenth aspect, alone or in combination with one or more of the first through seventeenth aspects, process 1100 includes transmitting, to the UE, a command for the UE to establish the second RRC connection, wherein establishing the second RRC connection is based at least in part on the command.

In a nineteenth aspect, alone or in combination with one or more of the first through eighteenth aspects, the command comprises an RRC configuration message, an RRC reconfiguration message, a MAC-CE, or an L1 command.

In a twentieth aspect, alone or in combination with one or more of the first through nineteenth aspects, process 1100 includes receiving, from the UE via random access control channel signaling, via an RRC setup complete message, or via an RRC reconfiguration complete message, an indication of whether a first condition associated with the dual connectivity or a second condition associated with the mobility procedure is satisfied.

In a twenty-first aspect, alone or in combination with one or more of the first through twentieth aspects, the signaling indicating the configuration for the second cell group comprises an RRC reconfiguration message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 3-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may establish a first RRC connection with a network node via a first cell group. The reception component 1202 may receive signaling indicating a configuration for a second cell group, wherein the configuration comprises an indication of whether the network node supports dual connectivity for the UE via the second cell group, whether the network node supports a mobility procedure for the UE via the second cell group, or both. The communication manager 1206 may establish, with the network node via the second cell group, a second RRC connection for the dual connectivity or for the mobility procedure based at least in part on whether the network node supports the dual connectivity, the mobility procedure, or both via the second cell group.

The communication manager 1206 may apply a portion of the configuration for the second cell group to the second RRC connection, wherein the portion of the configuration that is applied is based at least in part on whether the second RRC connection is established for the dual connectivity or for the mobility procedure.

The transmission component 1204 may transmit, to the network node via the second RRC connection, a message indicating a successful establishment of the second RRC connection, wherein the message further comprises an indication establishing that the second RRC connection is for the mobility procedure.

The communication manager 1206 may release the first RRC connection based at least in part on successfully establishing the second RRC connection.

The reception component 1202 may receive, from the network node via the second RRC connection, an indication to release the first RRC connection, wherein releasing the first RRC connection is based at least in part on receiving the indication to release the first RRC connection.

The reception component 1202 may receive, from the network node via the first RRC connection, signaling indicating for the UE to establish the second RRC connection and release the first RRC connection after successfully establishing the second RRC connection, wherein establishing the second RRC connection is based at least in part on receiving the signaling indicating for the UE to establish the second RRC connection.

The reception component 1202 may receive, via the first RRC connection, a MAC-CE indicating for the UE to perform the mobility procedure, wherein establishing the second RRC connection is based at least in part on receiving the MAC-CE.

The reception component 1202 may receive, from the network node, a command for the UE to establish the second RRC connection, wherein establishing the second RRC connection is based at least in part on the command.

The communication manager 1206 may determine that a first condition associated with the dual connectivity or a second condition associated with the mobility procedure is satisfied, wherein establishing the second RRC connection is based at least in part on the first condition or the second condition being satisfied.

The transmission component 1204 may transmit, via random access control channel signaling, via an RRC setup complete message, or via an RRC reconfiguration complete message, an indication of whether the first condition associated with the dual connectivity or the second condition associated with the mobility procedure is satisfied.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a Network Node, or a Network Node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system of the network node (for example the processing system 145 as described with reference to FIG. 1).

In some aspects, the apparatus 1300 may be configured to perform one or more operations described herein in connection with FIGS. 3-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may establish a first RRC connection with a UE via a first cell group. The transmission component 1304 may transmit signaling indicating a configuration for a second cell group, wherein the configuration comprises an indication of whether the network node supports dual connectivity for the UE via the second cell group, whether the network node supports a mobility procedure for the UE via the second cell group, or both. The communication manager 1306 may establish, with the UE via the second cell group, a second RRC connection for the dual connectivity or for the mobility procedure based at least in part on whether the network node supports the dual connectivity, the mobility procedure, or both via the second cell group.

The transmission component 1304 may transmit, from a central unit associated with the network node to a distributed unit associated with the network node, signaling indicating whether the network node supports dual connectivity for the UE via the second cell group, whether the network node supports a mobility procedure for the UE via the second cell group, or both.

The communication manager 1306 may apply a portion of the configuration for the second cell group to the second RRC connection, wherein the portion of the configuration that is applied is based at least in part on whether the second RRC connection is established for the dual connectivity or for the mobility procedure.

The transmission component 1304 may transmit, from a distributed unit associated with the network node to a central unit associated with the network node, signaling indicating whether the second RRC connection is for the dual connectivity or for the mobility procedure.

The reception component 1302 may receive an indication of whether the second RRC connection is for the dual connectivity or for the mobility procedure, wherein transmitting the signaling to the central unit associated with the network node comprises transmitting the signaling via an access success message.

The reception component 1302 may receive, from the UE via the second RRC connection, a message indicating a successful establishment of the second RRC connection, wherein the message further comprises an indication establishing that the second RRC connection is for the mobility procedure.

The transmission component 1304 may transmit, to the UE via the second RRC connection, an indication to release the first RRC connection based at least in part on receiving the message indicating the successful establishment of the second RRC connection.

The transmission component 1304 may transmit, to the UE via the first RRC connection, signaling indicating for the UE to establish the second RRC connection and release the first RRC connection after successfully establishing the second RRC connection, wherein establishing the second RRC connection is based at least in part on transmitting the signaling indicating for the UE to establish the second RRC connection.

The transmission component 1304 may transmit, to the UE by a distributed unit associated with the network node via the first RRC connection, a MAC-CE or a L1 command indicating for the UE to perform the mobility procedure, wherein establishing the second RRC connection is based at least in part on transmitting the MAC-CE.

The transmission component 1304 may transmit, from the distributed unit associated with the network node to a central unit associated with the network node, an indication for the central unit to activate the second cell group for the mobility procedure, wherein establishing the second RRC connection is based at least in part on the central unit activating the second cell group for the mobility procedure.

The transmission component 1304 may transmit, to the UE, a command for the UE to establish the second RRC connection, wherein establishing the second RRC connection is based at least in part on the command.

The reception component 1302 may receive, from the UE via random access control channel signaling or via an RRC setup complete message or via an RRC reconfiguration complete message, an indication of whether a first condition associated with the dual connectivity or a second condition associated with the mobility procedure is satisfied.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: establishing a first RRC connection with a network node via a first cell group; receiving signaling indicating a configuration for a second cell group, wherein the configuration comprises an indication of whether the network node supports dual connectivity for the UE via the second cell group, whether the network node supports a mobility procedure for the UE via the second cell group, or both; and establishing, with the network node via the second cell group, a second RRC connection for the dual connectivity or for the mobility procedure based at least in part on whether the network node supports the dual connectivity, the mobility procedure, or both via the second cell group.

Aspect 2: The method of Aspect 1, wherein the configuration for the second cell group further comprises: one or more signaling radio bearer and data radio bearer configurations associated with one or more layers of a protocol stack of the UE; an indication of one or more portions of the configuration that apply to the second RRC connection established for the dual connectivity; an indication of one or more portions of the configuration that apply to the second RRC connection established for the mobility procedure; a first condition associated with establishing the second RRC connection for the dual connectivity; or a second condition associated with establishing the second RRC connection for the mobility procedure.

Aspect 3: The method of any of Aspects 1-2, further comprising: applying a portion of the configuration for the second cell group to the second RRC connection, wherein the portion of the configuration that is applied is based at least in part on whether the second RRC connection is established for the dual connectivity or for the mobility procedure.

Aspect 4: The method of any of Aspects 1-3, wherein establishing the second RRC connection comprises establishing the second RRC connection for the dual connectivity.

Aspect 5: The method of Aspect 4, wherein the dual connectivity is triggered by a central unit associated with the network node, a distributed unit associated with the network node, or the UE.

Aspect 6: The method of any of Aspects 1-5, wherein establishing the second RRC connection comprises establishing the second RRC connection for the mobility procedure.

Aspect 7: The method of Aspect 6, further comprising: transmitting, to the network node via the second RRC connection, a message indicating a successful establishment of the second RRC connection, wherein the message further comprises an indication establishing that the second RRC connection is for the mobility procedure; and releasing the first RRC connection based at least in part on successfully establishing the second RRC connection.

Aspect 8: The method of Aspect 7, further comprising: receiving, from the network node via the second RRC connection, an indication to release the first RRC connection, wherein releasing the first RRC connection is based at least in part on receiving the indication to release the first RRC connection.

Aspect 9: The method of Aspect 6, further comprising: receiving, from the network node via the first RRC connection, signaling indicating for the UE to establish the second RRC connection and release the first RRC connection after successfully establishing the second RRC connection, wherein establishing the second RRC connection is based at least in part on receiving the signaling indicating for the UE to establish the second RRC connection.

Aspect 10: The method of Aspect 6, further comprising: receiving, via the first RRC connection, a MAC-CE indicating for the UE to perform the mobility procedure, wherein establishing the second RRC connection is based at least in part on receiving the MAC-CE.

Aspect 11: The method of Aspect 6, wherein the mobility procedure is triggered by a central unit associated with the network node, a distributed unit associated with the network node, or the UE.

Aspect 12: The method of Aspect 6, wherein the mobility procedure comprises a first handover procedure with a random access procedure, a make-before-break handover procedure, a conditional handover procedure, or a second handover procedure without a random access procedure.

Aspect 13: The method of any of Aspects 1-12, further comprising: receiving, from the network node, a command for the UE to establish the second RRC connection, wherein establishing the second RRC connection is based at least in part on the command.

Aspect 14: The method of Aspect 13, wherein the command comprises an RRC configuration message, an RRC reconfiguration message, a MAC-CE, or an L1 command.

Aspect 15: The method of any of Aspects 1-14, further comprising: determining that a first condition associated with the dual connectivity or a second condition associated with the mobility procedure is satisfied, wherein establishing the second RRC connection is based at least in part on the first condition or the second condition being satisfied.

Aspect 16: The method of Aspect 15, further comprising: transmitting, via random access control channel signaling, via an RRC setup complete message, or via an RRC reconfiguration complete message, an indication of whether the first condition associated with the dual connectivity or the second condition associated with the mobility procedure is satisfied.

Aspect 17: The method of any of Aspects 1-16, wherein the signaling indicating the configuration for the second cell group comprises an RRC reconfiguration message.

Aspect 18: A method of wireless communication performed by a network node, comprising: establish a first RRC connection with a UE via a first cell group; transmitting signaling indicating a configuration for a second cell group, wherein the configuration comprises an indication of whether the network node supports dual connectivity for the UE via the second cell group, whether the network node supports a mobility procedure for the UE via the second cell group, or both; and establishing, with the UE via the second cell group, a second RRC connection for the dual connectivity or for the mobility procedure based at least in part on whether the network node supports the dual connectivity, the mobility procedure, or both via the second cell group.

Aspect 19: The method of Aspect 18, further comprising: transmitting, from a central unit associated with the network node to a distributed unit associated with the network node, signaling indicating whether the network node supports dual connectivity for the UE via the second cell group, whether the network node supports a mobility procedure for the UE via the second cell group, or both.

Aspect 20: The method of any of Aspects 18-19, wherein the configuration for the second cell group further comprises: one or more signaling radio bearer and data radio bearer configurations associated with one or more layers of a protocol stack of the UE; an indication of one or more portions of the configuration that apply to the second RRC connection established for the dual connectivity; an indication of one or more portions of the configuration that apply to the second RRC connection established for the mobility procedure; a first condition associated with establishing the second RRC connection for the dual connectivity; or a second condition associated with establishing the second RRC connection for the mobility procedure.

Aspect 21: The method of any of Aspects 18-20, further comprising: applying a portion of the configuration for the second cell group to the second RRC connection, wherein the portion of the configuration that is applied is based at least in part on whether the second RRC connection is established for the dual connectivity or for the mobility procedure.

Aspect 22: The method of any of Aspects 18-21, further comprising: transmitting, from a distributed unit associated with the network node to a central unit associated with the network node, signaling indicating whether the second RRC connection is for the dual connectivity or for the mobility procedure.

Aspect 23: The method of Aspect 22, further comprising: receiving, by the distributed unit associated with the network node from the UE via random access control channel signaling, an indication of whether the second RRC connection is for the dual connectivity or for the mobility procedure, wherein transmitting the signaling to the central unit associated with the network node comprises transmitting the signaling via an access success message.

Aspect 24: The method of any of Aspects 18-23, wherein establishing the second RRC connection comprises establishing the second RRC connection for the dual connectivity.

Aspect 25: The method of Aspect 24, wherein the dual connectivity is triggered by a central unit associated with the network node, a distributed unit associated with the network node, or the UE.

Aspect 26: The method of any of Aspects 18-25, wherein establishing the second RRC connection comprises establishing the second RRC connection for the mobility procedure.

Aspect 27: The method of Aspect 26, further comprising: receiving, from the UE via the second RRC connection, a message indicating a successful establishment of the second RRC connection, wherein the message further comprises an indication establishing that the second RRC connection is for the mobility procedure.

Aspect 28: The method of Aspect 27, further comprising: transmitting, to the UE via the second RRC connection, an indication to release the first RRC connection based at least in part on receiving the message indicating the successful establishment of the second RRC connection.

Aspect 29: The method of Aspect 26, further comprising: transmitting, to the UE via the first RRC connection, signaling indicating for the UE to establish the second RRC connection and release the first RRC connection after successfully establishing the second RRC connection, wherein establishing the second RRC connection is based at least in part on transmitting the signaling indicating for the UE to establish the second RRC connection.

Aspect 30: The method of Aspect 26, further comprising: transmitting, to the UE by a distributed unit associated with the network node via the first RRC connection, a MAC-CE or an L1 command indicating for the UE to perform the mobility procedure, wherein establishing the second RRC connection is based at least in part on transmitting the MAC-CE.

Aspect 31: The method of Aspect 30, wherein the distributed unit is associated with the first cell group, the method further comprising: transmitting, by the distributed unit to a second distributed unit associated with the second cell group, an indication for the second distributed unit to activate the second cell group for the mobility procedure, wherein establishing the second RRC connection is based at least in part on the indication to activate the second cell group.

Aspect 32: The method of Aspect 30, further comprising: transmitting, from the distributed unit associated with the network node to a central unit associated with the network node, an indication for the central unit to activate the second cell group for the mobility procedure, wherein establishing the second RRC connection is based at least in part on the central unit activating the second cell group for the mobility procedure.

Aspect 33: The method of Aspect 30, wherein transmitting the MAC-CE or the L1 command to the UE indicating for the UE to perform the mobility procedure is based at least in part on a measurement report received by the distributed unit from the UE, load conditions associated with the network node, or a condition associated with the mobility procedure being satisfied.

Aspect 34: The method of Aspect 26, wherein the mobility procedure is triggered by a central unit associated with the network node, a distributed unit associated with the network node, or the UE.

Aspect 35: The method of Aspect 26, wherein the mobility procedure comprises a first handover procedure with a random access procedure, a make-before-break handover procedure, a conditional handover procedure, or a second handover procedure without a random access procedure.

Aspect 36: The method of any of Aspects 18-35, further comprising: transmitting, to the UE, a command for the UE to establish the second RRC connection, wherein establishing the second RRC connection is based at least in part on the command.

Aspect 37: The method of Aspect 36, wherein the command comprises an RRC configuration message, an RRC reconfiguration message, a MAC-CE, or an L1 command.

Aspect 38: The method of any of Aspects 18-37, further comprising: receiving, from the UE via random access control channel signaling, via an RRC setup complete message, or via an RRC reconfiguration complete message, an indication of whether a first condition associated with the dual connectivity or a second condition associated with the mobility procedure is satisfied.

Aspect 39: The method of any of Aspects 18-38, wherein the signaling indicating the configuration for the second cell group comprises an RRC reconfiguration message.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled to the one or more memories, the one or more processors individual or collectively configured to:
establish a first radio resource control (RRC) connection with a network node via a first cell group;
receive signaling indicating a configuration for a second cell group, wherein the configuration comprises an indication of whether the network node supports dual connectivity for the UE via the second cell group, whether the network node supports a mobility procedure for the UE via the second cell group, or both; and
establish, with the network node via the second cell group, a second RRC connection for the dual connectivity or for the mobility procedure based at least in part on whether the network node supports the dual connectivity, the mobility procedure, or both via the second cell group.

2. The apparatus of claim 1, wherein the configuration for the second cell group further comprises:
one or more signaling radio bearer and data radio bearer configurations associated with one or more layers of a protocol stack of the UE;
an indication of one or more portions of the configuration that apply to the second RRC connection established for the dual connectivity;
an indication of one or more portions of the configuration that apply to the second RRC connection established for the mobility procedure;
a first condition associated with establishing the second RRC connection for the dual connectivity; or
a second condition associated with establishing the second RRC connection for the mobility procedure.

3. The apparatus of claim 1, wherein the one or more processors are further configured to:
apply a portion of the configuration for the second cell group to the second RRC connection, wherein the portion of the configuration that is applied is based at least in part on whether the second RRC connection is established for the dual connectivity or for the mobility procedure.

4. The apparatus of claim 1, wherein the one or more processors, to cause the UE to establish the second RRC connection, are configured to establish the second RRC connection for the dual connectivity.

5. The apparatus of claim 4, wherein the dual connectivity is triggered by a central unit associated with the network node, a distributed unit associated with the network node, or the UE.

6. The apparatus of claim 1, wherein the one or more processors, to cause the UE to establish the second RRC connection, are configured to establish the second RRC connection for the mobility procedure.

7. The apparatus of claim 6, wherein the one or more processors are further configured to:
transmit, to the network node via the second RRC connection, a message indicating a successful establishment of the second RRC connection, wherein the message further comprises an indication establishing that the second RRC connection is for the mobility procedure; and
release the first RRC connection based at least in part on successfully establishing the second RRC connection.

8. The apparatus of claim 7, wherein the one or more processors are further configured to:
receive, from the network node via the second RRC connection, an indication to release the first RRC connection, wherein releasing the first RRC connection is based at least in part on receiving the indication to release the first RRC connection.

9. The apparatus of claim 6, wherein the one or more processors are further configured to:
receive, from the network node via the first RRC connection, signaling indicating for the UE to establish the second RRC connection and release the first RRC connection after successfully establishing the second RRC connection, wherein establishing the second RRC connection is based at least in part on receiving the signaling indicating for the UE to establish the second RRC connection.

10. The apparatus of claim 6, wherein the one or more processors are further configured to:
receive, via the first RRC connection, a medium access control-control element (MAC-CE) indicating for the UE to perform the mobility procedure, wherein establishing the second RRC connection is based at least in part on receiving the MAC-CE.

11. The apparatus of claim 6, wherein the mobility procedure is triggered by a central unit associated with the network node, a distributed unit associated with the network node, or the UE.

12. The apparatus of claim 6, wherein the mobility procedure comprises a first handover procedure with a random access procedure, a make-before-break handover procedure, a conditional handover procedure, or a second handover procedure without a random access procedure.

13. The apparatus of claim 1, wherein the one or more processors are further configured to:
receive, from the network node, a command for the UE to establish the second RRC connection, wherein establishing the second RRC connection is based at least in part on the command.

14. The apparatus of claim 1, wherein the one or more processors are further configured to:
determine that a first condition associated with the dual connectivity or a second condition associated with the mobility procedure is satisfied, wherein establishing the second RRC connection is based at least in part on the first condition or the second condition being satisfied.

15. The apparatus of claim 14, wherein the one or more processors are further configured to:
transmit, via random access control channel signaling, via an RRC setup complete message, or via an RRC reconfiguration complete message, an indication of whether the first condition associated with the dual connectivity or the second condition associated with the mobility procedure is satisfied.

16. An apparatus for wireless communication at a network node, comprising:
one or more memories; and
one or more processors coupled to the one or more memories, the one or more processors individual or collectively configured to:
establish a first radio resource control (RRC) connection with a user equipment (UE) via a first cell group;
transmit signaling indicating a configuration for a second cell group, wherein the configuration comprises an indication of whether the network node supports dual connectivity for the UE via the second cell group, whether the network node supports a mobility procedure for the UE via the second cell group, or both; and
establish, with the UE via the second cell group, a second RRC connection for the dual connectivity or for the mobility procedure based at least in part on whether the network node supports the dual connectivity, the mobility procedure, or both via the second cell group.

17. The apparatus of claim 16, wherein the one or more processors are further configured to:
transmit, from a central unit associated with the network node to a distributed unit associated with the network node, signaling indicating whether the network node supports dual connectivity for the UE via the second cell group, whether the network node supports a mobility procedure for the UE via the second cell group, or both.

18. The apparatus of claim 16, wherein the one or more processors are further configured to:
transmit, from a distributed unit associated with the network node to a central unit associated with the network node, signaling indicating whether the second RRC connection is for the dual connectivity or for the mobility procedure.

19. The apparatus of claim 18, wherein the one or more processors are further configured to:
receive an indication of whether the second RRC connection is for the dual connectivity or for the mobility procedure, wherein transmitting the signaling to the central unit associated with the network node comprises transmitting the signaling via an access success message.

20. The apparatus of claim 16, wherein the one or more processors, to cause the network node to establish the second RRC connection, are configured to establish the second RRC connection for the dual connectivity.

21. The apparatus of claim 16, wherein the one or more processors, to cause the network node to establish the second RRC connection, are configured to establish the second RRC connection for the mobility procedure.

22. The apparatus of claim 21, wherein the one or more processors are further configured to:
receive, from the UE via the second RRC connection, a message indicating a successful establishment of the second RRC connection, wherein the message further comprises an indication establishing that the second RRC connection is for the mobility procedure.

23. The apparatus of claim 21, wherein the one or more processors are further configured to:
transmit, to the UE via the first RRC connection, signaling indicating for the UE to establish the second RRC connection and release the first RRC connection after successfully establishing the second RRC connection, wherein establishing the second RRC connection is based at least in part on transmitting the signaling indicating for the UE to establish the second RRC connection.

24. The apparatus of claim 21, wherein the one or more processors are further configured to:
transmit, to the UE by a distributed unit associated with the network node via the first RRC connection, a medium access control-control element (MAC-CE) or a layer 1 (L1) command indicating for the UE to perform the mobility procedure, wherein establishing the second RRC connection is based at least in part on transmitting the MAC-CE.

25. The apparatus of claim 24, wherein the distributed unit is associated with the first cell group, and wherein the one or more processors are further configured to:
transmit, by the distributed unit to a second distributed unit associated with the second cell group, an indication for the second distributed unit to activate the second cell group for the mobility procedure, wherein establishing the second RRC connection is based at least in part on the indication to activate the second cell group.

26. The apparatus of claim 24, wherein the one or more processors are further configured to:
transmit, from the distributed unit associated with the network node to a central unit associated with the network node, an indication for the central unit to activate the second cell group for the mobility procedure, wherein establishing the second RRC connection is based at least in part on the central unit activating the second cell group for the mobility procedure.

27. The apparatus of claim 16, wherein the one or more processors are further configured to:
transmit, to the UE, a command for the UE to establish the second RRC connection, wherein establishing the second RRC connection is based at least in part on the command.

28. The apparatus of claim 16, wherein the one or more processors are further configured to:
receive, from the UE via random access control channel signaling, via an RRC setup complete message, or via an RRC reconfiguration complete message, an indication of whether a first condition associated with the dual connectivity or a second condition associated with the mobility procedure is satisfied.

29. A method of wireless communication performed by a user equipment (UE), comprising:
establishing a first radio resource control (RRC) connection with a network node via a first cell group;
receiving signaling indicating a configuration for a second cell group, wherein the configuration comprises an indication of whether the network node supports dual connectivity for the UE via the second cell group, whether the network node supports a mobility procedure for the UE via the second cell group, or both; and
establishing, with the network node via the second cell group, a second RRC connection for the dual connectivity or for the mobility procedure based at least in part on whether the network node supports the dual connectivity, the mobility procedure, or both via the second cell group.

30. A method of wireless communication performed by a network node, comprising:
establish a first radio resource control (RRC) connection with a user equipment (UE) via a first cell group;
transmitting signaling indicating a configuration for a second cell group, wherein the configuration comprises an indication of whether the network node supports dual connectivity for the UE via the second cell group, whether the network node supports a mobility procedure for the UE via the second cell group, or both; and
establishing, with the UE via the second cell group, a second RRC connection for the dual connectivity or for the mobility procedure based at least in part on whether the network node supports the dual connectivity, the mobility procedure, or both via the second cell group.
